(19) United States
(12) Patent Application Publication
(10) Pub. No.: US 2015/0005910 A1
(43) Pub. Date: Jan. 1, 2015

(54) MOTION INFORMATION PROCESSING APPARATUS AND METHOD

(71) Applicants: Kabushiki Kaisha Toshiba, Minato-ku (JP); Toshiba Medical Systems Corporation, Otawara-shi (JP)

(72) Inventors: Shigeyuki ISHII, Nasushiobara-shi (JP); Kazuki UTSUNOMIYA, Nasushiobara-shi (JP); Kousuke SAKAUE, Nasushiobara-shi (JP); Satoshi IKEDA, Yaita-shi (JP); Yoshihisa YOSHIOKA, Nasushiobara-shi (JP)

(73) Assignees: Kabushiki Kaisha Toshiba, Minato-ku (JP); Toshiba Medical Systems Corporation, Otawara-shi (JP)

(21) Appl. No.: 14/317,329

(22) Filed: Jun. 27, 2014

(30) Foreign Application Priority Data
Jul. 1, 2013 (JP) 2013-138281
Jul. 1, 2013 (JP) 2013-138303

(51) Int. Cl. G06K 9/00

(52) U.S. Cl. CPC G06K 9/00342
USPC 700/91

(57) ABSTRACT

A motion information processing apparatus according to an embodiment includes an obtaining unit, a judging unit, and a controlling unit. The obtaining unit obtains motion information of a subject who performs a motion of at least one of a squat and a jump. On the basis of predetermined conditions for the motion of at least one of the squat and the jump, the judging unit judges whether the motion of the subject indicated by the motion information obtained by the obtaining unit satisfies a certain condition included in the predetermined conditions. The controlling unit exercises control so that a judgment result obtained by the judging unit is provided as a notification.

### CROSS-REFERENCE TO RELATED APPLICATIONS

This application is based upon and claims the benefit of priority from Japanese Patent Application No. 2013-138281, filed on Jul. 1, 2013; and Japanese Patent Application No. 2013-138303, filed on Jul. 1, 2013, the entire contents of all of which are incorporated herein by reference.

### FIELD

Embodiments described herein relate generally to a motion information processing apparatus and a method.

### BACKGROUND

Conventionally, in rehabilitation, a number of experts provide cooperative support to enable persons who have mental and physical disabilities caused by various reasons, such as diseases, injuries, and aging, and congenital disabilities to live better lives. In rehabilitation, for example, cooperative support is provided by a number of experts, such as rehabilitation specialists, rehabilitation nurses, physical therapists, occupational therapists, speech-language-hearing therapists, clinical psychologists, prosthetists, and social workers.

In recent years, there have been developed motion capture technologies for digitally recording a motion of a person or an object. Examples of systems of the motion capture technologies include an optical, a mechanical, a magnetic, and a camera system. Widely known is the camera system for digitally recording a motion of a person by attaching markers to the person, detecting the markers with a tracker, such as a camera, and processing the detected markers, for example. Examples of systems using no marker or no tracker include a system for digitally recording a motion of a person by using an infrared sensor, measuring a distance from the sensor to the person, and detecting the size of the person and various types of motions of the skeletal structure. Examples of the sensors provided with such a system include Kinect (registered trademark).

### BRIEF DESCRIPTION OF THE DRAWINGS

FIG. 1 is a diagram of an exemplary configuration of a motion information processing apparatus according to a first embodiment;

FIG. 2A is a drawing for explaining a process performed by a motion information generating unit according to the first embodiment;

FIG. 2B is another drawing for explaining the process performed by the motion information generating unit according to the first embodiment;

FIG. 2C is yet another drawing for explaining the process performed by the motion information generating unit according to the first embodiment;

FIG. 3 is a table of examples of skeleton information generated by the motion information generating unit according to the first embodiment;

FIG. 4 is a diagram of an exemplary detailed configuration of the motion information processing apparatus according to the first embodiment;

FIG. 5 is a table of examples of motion information stored in a motion information storage unit according to the first embodiment;

FIG. 6 is a drawing for explaining postures of a subject during rehabilitation squat training according to the first embodiment;

FIG. 7 is a drawing of an example of skeleton information obtained by an obtaining unit according to the first embodiment;

FIG. 8A is a drawing for explaining an example of a squat training judging process performed by a judging unit according to the first embodiment;

FIG. 8B is a drawing for explaining an example of a judging process performed by the judging unit according to the first embodiment to judge whether squat training is performed;

FIG. 9 is a drawing of an example of displayed contents on which display control is exercised by a display controlling unit according to the first embodiment;

FIG. 10 is a drawing of another example of displayed contents on which display control is exercised by the display controlling unit according to the first embodiment;

FIG. 11 is a drawing of yet another example of displayed contents on which display control is exercised by the display controlling unit according to the first embodiment;

FIG. 12 is a drawing of yet another example of displayed contents on which display control is exercised by the display controlling unit according to the first embodiment;

FIG. 13 is a flowchart of a procedure in a process performed by the motion information processing apparatus according to the first embodiment;

FIG. 14A is a drawing for explaining an example of a squat training judging process performed by a judging unit according to a second embodiment;

FIG. 14B is a drawing for explaining another example of the squat training judging process performed by the judging unit according to the second embodiment;

FIG. 14C is a drawing for explaining yet another example of the squat training judging process performed by the judging unit according to the second embodiment;

FIG. 15 is a drawing for explaining an example of a squat training judging process performed by a judging unit according to a third embodiment;

FIG. 16 is a drawing for explaining a modification example of the squat training judging process performed by the judging unit according to the third embodiment;

FIG. 17 is a diagram of an exemplary detailed configuration of a motion information processing apparatus according to a fourth embodiment;

FIG. 18 is a drawing for explaining postures of a subject during rehabilitation jump training according to the fourth embodiment;

FIG. 19 is a drawing of an example of skeleton information obtained by an obtaining unit according to the fourth embodiment;

FIG. 20 is a drawing for explaining an example of a jump training judging process performed by a judging unit according to the fourth embodiment;

FIG. 21 is a drawing for explaining an example of a judging process performed by the judging unit according to the fourth embodiment to judge whether jump training is performed;

FIG. 22 is a drawing of an example of displayed contents on which display control is exercised by a display controlling unit according to the fourth embodiment;

FIG. 23 is a drawing of another example of displayed contents on which display control is exercised by the display controlling unit according to the fourth embodiment;

FIG. 24 is a drawing of yet another example of displayed contents on which display control is exercised by the display controlling unit according to the fourth embodiment;

FIG. 25 is a drawing of yet another example of displayed contents on which display control is exercised by the display controlling unit according to the fourth embodiment;

FIG. 26 is a flowchart of a procedure in a process performed by the motion information processing apparatus according to the fourth embodiment;

FIG. 27 is another flowchart of the procedure in the process performed by the motion information processing apparatus according to the fourth embodiment;

FIG. 28 is a drawing for explaining an example of a jump training judging process performed by a judging unit according to a fifth embodiment;

FIG. 29 is a drawing for explaining an example of a jump training judging process performed by a judging unit according to a sixth embodiment;

FIG. 30 is a drawing for explaining another example of the jump training judging process performed by the judging unit according to the sixth embodiment; and

FIG. 31 is a drawing for explaining an example in which a configuration is applied to a service providing apparatus according to a seventh embodiment.

### DETAILED DESCRIPTION

According to embodiment, A motion information processing apparatus comprising, an obtaining unit, a judging unit and a controlling unit. The obtaining unit configured to obtain motion information of a subject who performs a motion of at least one of a squat and a jump. The judging unit configured to, on a basis of predetermined conditions for the motion of said at least one of the squat and the jump, judge whether the motion of the subject indicated by the motion information obtained by the obtaining unit satisfies a certain condition included in the predetermined conditions. The controlling unit configured to exercise control so that a judgment result obtained by the judging unit is provided as a notification.

Exemplary embodiments of a motion information processing apparatus and a method are described below with reference to the accompanying drawings. Motion information processing apparatuses described below may be used alone or in a manner incorporated in a system, such as a medical chart system and a rehabilitation section system.

### First Embodiment

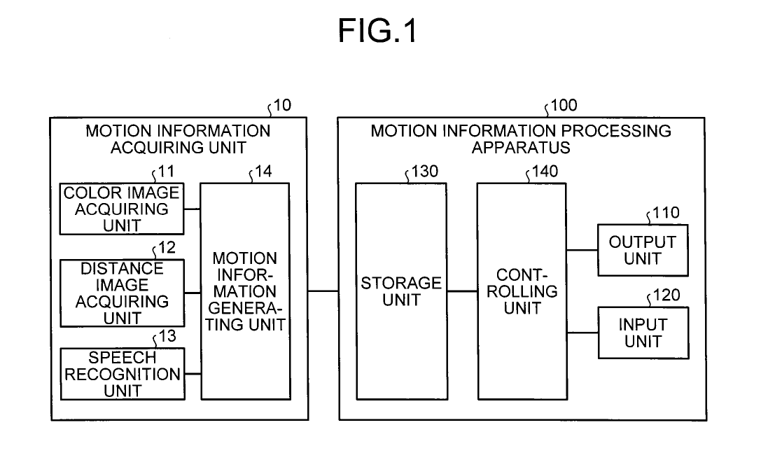

FIG. 1 is a diagram of an exemplary configuration of a motion information processing apparatus 100 according to a first embodiment. The motion information processing apparatus 100 according to the first embodiment is an apparatus that supports rehabilitation performed at medical institutions, home, and offices, for example. “Rehabilitation” means a technology and a method for enhancing potential of patients receiving long-term treatment for disabilities, chronic diseases, geriatric diseases, and the like to restore and improve vital functions and social functions of the patients. Such a technology and a method include functional training to restore and improve vital functions and social functions, for example. Examples of the functional training include gait training and range of joint motion exercises. A person serving as a target of rehabilitation is referred to as a “subject”. Examples of the subject include sick persons, injured persons, elderly persons, and disabled persons. A person who assists the subject in rehabilitation is referred to as a “caregiver”. Examples of the caregiver include medical professionals who work for medical institutions, such as doctors, physical therapists, and nurses, and care workers, families, and friends who care for the subject at home. Rehabilitation may be simply referred to as “rehab”.

As illustrated in FIG. 1, the motion information processing apparatus 100 is connected to a motion information acquiring unit 10 in the first embodiment.

The motion information acquiring unit 10 detects a motion of a person, an object, or the like in a space where rehabilitation is performed, thereby acquiring motion information indicating the motion of the person, the object, or the like. The motion information will be described in detail in an explanation of processing of a motion information generating unit 14, which will be described later. The motion information acquiring unit 10 is Kinect (registered trademark), for example.

As illustrated in FIG. 1, the motion information acquiring unit 10 includes a color image acquiring unit 11, a distance image acquiring unit 12, a speech recognition unit 13, and the motion information generating unit 14. The configuration of the motion information acquiring unit 10 illustrated in FIG. 1 is given by way of example, and the embodiment is not limited thereto.

The color image acquiring unit 11 captures a photographic subject, such as a person and an object, in a space where rehabilitation is performed, thereby acquiring color image information. The color image acquiring unit 11, for example, detects light reflected by the surface of the photographic subject with a light receiving element and converts visible light into an electrical signal. The color image acquiring unit 11 then converts the electrical signal into digital data, thereby generating color image information of one frame corresponding to a capturing range. The color image information of one frame includes capturing time information and information in which each pixel contained in the frame is associated with an RGB (red, green, and blue) value, for example. The color image acquiring unit 11 generates color image information of a plurality of consecutive frames from visible light sequentially detected, thereby capturing the capturing range as video. The color image information generated by the color image acquiring unit 11 may be output as a color image in which the RGB values of respective pixels are arranged on a bit map. The color image acquiring unit 11 includes a complementary metal oxide semiconductor (CMOS) and a charge coupled device (CCD) as the light receiving element, for example.

The distance image acquiring unit 12 captures a photographic subject, such as a person and an object, in a space where rehabilitation is performed, thereby acquiring distance image information. The distance image acquiring unit 12, for example, irradiates the surroundings with infrared rays and detects reflected waves, which are irradiation waves reflected by the surface of the photographic subject, with a light receiving element. The distance image acquiring unit 12 then derives a distance between the photographic subject and the distance image acquiring unit 12 based on the phase difference between the irradiation waves and the reflected waves and a time from the irradiation to the detection. The distance image acquiring unit 12 thus generates distance image information of one frame corresponding to the capturing range. The distance image information of one frame includes capturing time information and information in which each pixel contained in the capturing range is associated with a distance between the photographic subject corresponding to the pixel and the distance image acquiring unit 12, for example. The distance image acquiring unit 12 generates distance image information of a plurality of consecutive frames from reflected waves sequentially detected, thereby capturing the capturing range as video. The distance image information generated by the distance image acquiring unit 12 may be output as a distance image in which the gray scales of colors corresponding to the distances of the respective pixels are arranged on a bit map. The distance image acquiring unit 12 includes a CMOS and a CCD as the light receiving element, for example. The light receiving element may be shared by the color image acquiring unit 11. The unit of distance calculated by the distance image acquiring unit 12 is the meter (m), for example.

The speech recognition unit 13 collects speech of the surroundings, identifies the direction of a sound source, and recognizes the speech. The speech recognition unit 13 includes a microphone array provided with a plurality of microphones and performs beam forming. Beam forming is a technology for selectively collecting speech travelling in a specific direction. The speech recognition unit 13, for example, performs beam forming with the microphone array, thereby identifying the direction of a sound source. The speech recognition unit 13 uses a known speech recognition technology, thereby recognizing a word from the collected speech. In other words, the speech recognition unit 13 generates information in which a word recognized by the speech recognition technology, the direction in which the word is output, and time at which the word is recognized are associated with one another as a speech recognition result, for example.

The motion information generating unit 14 generates motion information indicating a motion of a person, an object, or the like. The motion information is generated by considering a motion (gesture) of a person as a plurality of successive postures (poses), for example. Specifically, the motion information generating unit 14 performs pattern matching using a human body pattern. The motion information generating unit 14 acquires coordinates of respective joints forming a skeletal structure of a human body from the distance image information generated by the distance image acquiring unit 12. The coordinates of respective joints obtained from the distance image information are values represented by a coordinate system of a distance image (hereinafter, referred to as a “distance image coordinate system”). The motion information generating unit 14 then converts the coordinates of respective joints in the distance image coordinate system into values represented by a coordinate system of a three-dimensional space in which rehabilitation is performed (hereinafter, referred to as a “world coordinate system”). The coordinates of respective joints represented by the world coordinate system correspond to skeletal information of one frame. Skeletal information of a plurality of frames corresponds to motion information. The processing of the motion information generating unit 14 according to the first embodiment will be specifically described.

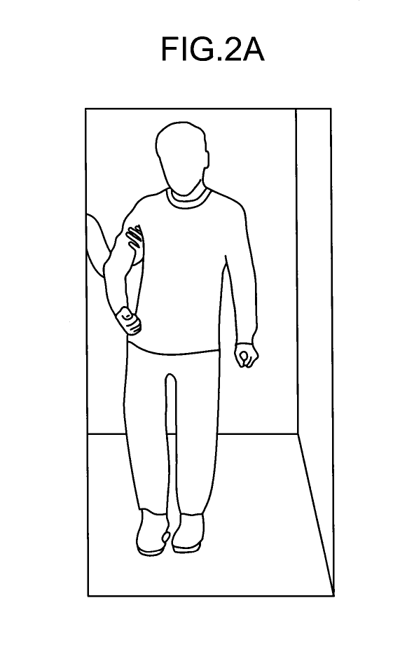

FIG. 2A to FIG. 2C are views for explaining the processing of the motion information generating unit 14 according to the first embodiment. FIG. 2A illustrates an example of a distance image generated by the distance image acquiring unit 12. While FIG. 2A illustrates an image depicted with lines for convenience of explanation, an actual distance image is an image represented by the gray scales of colors corresponding to distances, for example. In the distance image, each pixel has a three-dimensional value in which a “pixel position X” in the horizontal direction of the distance image, a “pixel position Y” in the vertical direction of the distance image, and a “distance Z” between the photographic subject corresponding to the pixel and the distance image acquiring unit 12 are associated with one another. A coordinate value in the distance image coordinate system is hereinafter represented by the three-dimensional value (X, Y, Z).

In the first embodiment, the motion information generating unit 14 stores therein in advance a human body pattern corresponding to various postures by learning, for example. Every time the distance image acquiring unit 12 generates distance image information, the motion information generating unit 14 acquires the generated distance image information of each frame. The motion information generating unit 14 then performs pattern matching of the human body pattern with the acquired distance image information of each frame.

The human body pattern will now be described. FIG. 2B illustrates an example of the human body pattern. In the first embodiment, the human body pattern is a pattern used for pattern matching with the distance image information. The human body pattern is represented by the distance image coordinate system and has information on the surface of a human body (hereinafter, referred to as a “human body surface”) similarly to the person depicted on the distance image. The human body surface corresponds to the skins of the person and the surfaces of clothes, for example. As illustrated in FIG. 2B, the human body pattern has information on joints forming the skeletal structure of the human body. In other words, a relative positional relation between the human body surface and each joint in the human body pattern is known.

In the example of FIG. 2B, the human body pattern has information on 20 joints from a joint 2a to a joint 2t. The joint 2a corresponds to the head, the joint 2b corresponds to the intermediate portion between the shoulders, the joint 2c corresponds to the waist, and the joint 2d corresponds to the center portion of the buttocks. The joint 2e corresponds to the right shoulder, the joint 2f corresponds to the right elbow, the joint 2g corresponds to the right wrist, and the joint 2h corresponds to the right hand. The joint 2i corresponds to the left shoulder, the joint 2j corresponds to the left elbow, the joint 2k corresponds to the left wrist, and the joint 2l corresponds to the left hand. The joint 2m corresponds to the right buttock, the joint 2n corresponds to the right knee, the joint 2o corresponds to the right ankle, and the joint 2p corresponds to the tarsus of the right foot. The joint 2q corresponds to the left buttock, the joint 2r corresponds to the left knee, the joint 2s corresponds to the left ankle, and the joint 2t corresponds to the tarsus of the left foot.

While the explanation has been made of the case where the body pattern has the information on 20 joints in FIG. 2B, the embodiment is not limited thereto. The positions and the number of joints may be optionally set by an operator. To grasp a change in a motion of the four limbs alone, for example, the information on the joint 2b and the joint 2c need not be acquired out of the joint 2a to the joint 2d. To grasp a change in a motion of the right hand in detail, joints of the fingers of the right hand may be further set besides the joint 2h. The joint 2a, the joint 2h, the joint 2l, the joint 2p, and the joint 2t in FIG. 2B correspond to distal ends of bones and are different from what is called a joint. Because the joints 2a, 2h, 2l, 2p, and 2t are important points indicating the positions and the directions of the bones, the joints 2a, 2h, 2l, 2p, and 2t are described herein as joints for convenience of explanation.

The motion information generating unit 14 performs pattern matching of the human body pattern with the distance image information of each frame. The motion information generating unit 14, for example, performs pattern matching of the human body surface of the human body pattern illustrated in FIG. 2B with the distance image illustrated in FIG. 2A, thereby extracting a person in a certain posture from the distance image information. Thus, the motion information generating unit 14 obtains the coordinates of the human body surface of the person extracted from the distance image. As described above, a relative positional relation between the human body surface and each joint in the human body pattern is known. The motion information generating unit 14 calculates the coordinates of the respective joints in the person from the coordinates of the human body surface of the person extracted from the distance image. As illustrated in FIG. 2C, the motion information generating unit 14 obtains the coordinates of the respective joints forming the skeletal structure of the human body from the distance image information. The obtained coordinates of the respective joints are coordinates in the distance coordinate system.

In the pattern matching, the motion information generating unit 14 may supplementarily use information indicating the positional relation of the joints. The information indicating the positional relation of the joints includes connection relations between joints (e.g., “the joint 2a and the joint 2b are connected”) and ranges of motion of the respective joints, for example. A joint is a part connecting two or more bones. An angle formed by bones changes in association with a change in posture, and the range of motion varies depending on the joints. The range of motion is represented by the maximum value and the minimum value of the angle formed by bones connected by a joint, for example. The motion information generating unit 14 also learns the ranges of motion of the respective joints in the learning of the human body pattern, for example. The motion information generating unit 14 stores therein the ranges of motion in association with the respective joints.

The motion information generating unit 14 converts the coordinates of the respective joints in the distance image coordinate system into values represented by the world coordinate system. The world coordinate system is a coordinate system of a three-dimensional space where rehabilitation is performed. In the world coordinate system, the position of the motion information acquiring unit 10 is set as an origin, the horizontal direction corresponds to an x-axis, the vertical direction corresponds to a y-axis, and a direction orthogonal to the xy-plane corresponds to a z-axis, for example. The value of the coordinates in the z-axis direction may be referred to as a “depth”.

The following describes the conversion processing from the distance image coordinate system to the world coordinate system. In the first embodiment, the motion information generating unit 14 stores therein in advance a conversion equation used for conversion from the distance image coordinate system to the world coordinate system. The conversion equation receives coordinates in the distance image coordinate system and an incident angle of reflected light corresponding to the coordinates and outputs coordinates in the world coordinate system, for example. The motion information generating unit 14, for example, inputs coordinates (X1, Y1, Z1) of a certain joint and an incident angle of reflected light corresponding to the coordinates to the conversion equation, thereby converting the coordinates (X1, Y1, Z1) of the certain joint into coordinates (x1, y1, z1) in the world coordinate system. Because the correspondence relation between the coordinates in the distance image coordinate system and the incident angle of reflected light is known, the motion information generating unit 14 can input the incident angle corresponding to the coordinates (X1, Y1, Z1) to the conversion equation. The explanation has been made of the case where the motion information generating unit 14 converts the coordinates in the distance image coordinate system into the coordinates in the world coordinate system. Alternatively, the motion information generating unit 14 can convert the coordinates in the world coordinate system into the coordinates in the distance image coordinate system.

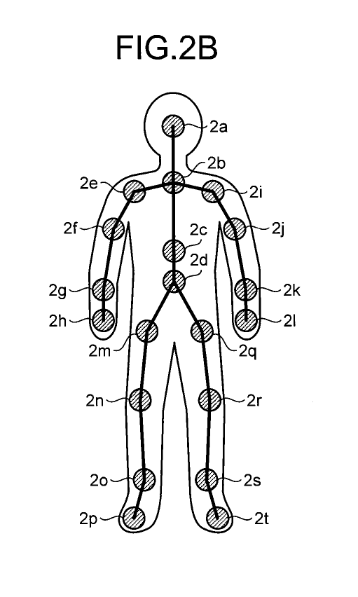

The motion information generating unit 14 generates skeletal information from the coordinates of the respective joints represented by the world coordinate system. FIG. 3 is a diagram of an example of the skeletal information generated by the motion information generating unit 14. The skeletal information of each frame includes capturing time information of the frame and the coordinates of the respective joints. As illustrated in FIG. 3, the motion information generating unit 14 generates skeletal information in which joint identification information is associated with coordinate information, for example. In FIG. 3, the capturing time information is not illustrated. The joint identification information is identification information used to identify a joint and is set in advance. Joint identification information “2a” corresponds to the head, and joint identification information “2b” corresponds to the intermediate portion between the shoulders, for example. The other pieces of joint identification information similarly indicate respective joints corresponding thereto. The coordinate information indicates the coordinates of the respective joints in each frame in the world coordinate system.

In the first row of FIG. 3, the joint identification information “2a” is associated with coordinate information “(x1, y1, z1)”. In other words, the skeletal information listed in FIG. 3 indicates that the head is present at the position of the coordinates (x1, y1, z1) in a certain frame. In the second row of FIG. 3, the joint identification information “2b” is associated with coordinate information “(x2, y2, z2)”. In other words, the skeletal information listed in FIG. 3 indicates that the intermediate portion between the shoulders is present at the position of the coordinates (x2, y2, z2) in the certain frame. The other pieces of joint identification information similarly indicate that the joints are present at the positions of the respective coordinates in the certain frame.

Every time the motion information generating unit 14 receives the distance image information of each frame from the distance image acquiring unit 12, the motion information generating unit 14 performs pattern matching on the distance image information of each frame. The motion information generating unit 14 thus performs conversion from the distance image coordinate system to the world coordinate system, thereby generating the skeletal information of each frame. The motion information generating unit 14 then outputs the generated skeletal information of each frame to the motion information processing apparatus 100 and stores the skeletal information in a motion information storage unit, which will be described later.

The processing of the motion information generating unit 14 is not necessarily performed by the method described above. While the explanation has been made of the method in which the motion information generating unit 14 uses a human body pattern to perform pattern matching, the embodiment is not limited thereto. Instead of the human body pattern or in addition to the human body pattern, the motion information generating unit 14 may use a pattern of each part to perform pattern matching.

While the explanation has been made of the method in which the motion information generating unit 14 obtains the coordinates of the respective joints from the distance image information in the description above, for example, the present embodiment is not limited thereto. The motion information generating unit 14 may obtain the coordinates of respective joints using color image information in addition to the distance image information, for example. In this case, the motion information generating unit 14, for example, performs pattern matching of a human body pattern represented by a color image coordinate system with the color image information, thereby obtaining the coordinates of the human body surface from the color image information. The color image coordinate system has no information on “distance Z” included in the distance image coordinate system. The motion information generating unit 14 acquires the information on “distance Z” from the distance image information, for example. The motion information generating unit 14 then performs arithmetic processing using the two pieces of information, thereby obtaining the coordinates of the respective joints in the world coordinate system.

The motion information generating unit 14 outputs the color image information generated by the color image acquiring unit 11, the distance image information generated by the distance image acquiring unit 12, and the speech recognition result output from the speech recognition unit 13 to the motion information processing apparatus 100 as needed. The motion information generating unit 14 then stores the pieces of information in the motion information storage unit, which will be described later. Pixel positions in the color image information can be associated with pixel positions in the distance image information in advance based on the positions of the color image acquiring unit 11 and the distance image acquiring unit 12 and the capturing direction. As a result, the pixel positions in the color image information and the pixel positions in the distance image information can also be associated with the world coordinate system derived by the motion information generating unit 14. The association processing and the use of the distance (m) calculated by the distance image acquiring unit 12 makes it possible to calculate the height and the length of each part of the body (the length of the arm and the length of the abdomen) and to calculate the distance between two pixels specified on a color image. Similarly, the capturing time information of the color image information can be associated with the capturing time information of the distance image information in advance. The motion information generating unit 14 refers to the speech recognition result and the distance image information. If the joint 2a is present near the direction in which a word recognized as speech at certain time is spoken, the motion information generating unit 14 can output the word as a word spoken by a person having the joint 2a. The motion information generating unit 14 outputs the information indicating the positional relation of the joints to the motion information processing apparatus 100 as needed and stores the information in the motion information storage unit, which will be described later.

While the explanation has been made of the case where the motion information acquiring unit 10 detects a motion of one person, the embodiment is not limited thereto. If a plurality of persons are included in the capturing range of the motion information acquiring unit 10, the motion information acquiring unit 10 may detect motions of the persons. If a plurality of persons are captured in the distance image information of a single frame, the motion information acquiring unit 10 associates pieces of skeletal information on the persons generated from the distance image information of the single frame with one another. The motion information acquiring unit 10 then outputs the skeletal information to the motion information processing apparatus 100 as the motion information.

The configuration of the motion information acquiring unit 10 is not limited to the configuration described above. In the case where the motion information is generated by detecting a motion of a person with another motion capture, such as an optical, a mechanical, or a magnetic motion capture, for example, the motion information acquiring unit 10 does not necessarily include the distance image acquiring unit 12. In this case, the motion information acquiring unit 10 includes markers attached to the human body so as to detect a motion of the person and a sensor that detects the markers as a motion sensor. The motion information acquiring unit 10 detects a motion of the person with the motion sensor, thereby generating the motion information. The motion information acquiring unit 10 uses the positions of the markers included in an image captured by the color image acquiring unit 11 to associate the pixel positions in the color image information with the coordinates in the motion information. The motion information acquiring unit 10 outputs the motion information to the motion information processing apparatus 100 as needed. In the case where the motion information acquiring unit 10 outputs no speech recognition result to the motion information processing apparatus 100, for example, the motion information acquiring unit 10 does not necessarily include the speech recognition unit 13.

While the motion information acquiring unit 10 outputs the coordinates in the world coordinate system as the skeletal information in the embodiment, the embodiment is not limited thereto. The motion information acquiring unit 10 may output the coordinates in the distance image coordinate system yet to be converted, for example. The conversion from the distance image coordinate system to the world coordinate system may be performed by the motion information processing apparatus 100 as needed.

Returning to the description of FIG. 1, the motion information processing apparatus 100 performs a process to aid rehabilitation (which hereinafter may be referred to as “rehab”) by using the motion information output from the motion information acquiring unit 10. More specifically, the motion information processing apparatus 100 is configured to evaluate a motion of a squat or a jump performed by a subject, by using the motion information of the subject who performs training of the motion of the squat or the jump, the motion information being acquired by the motion information acquiring unit 10.

As explained above, various types of training are conventionally performed as part of rehabilitation functional training. For example, from the standpoint of preventive medicine and sports medicine, squat training and jump training are performed as rehabilitation functional training. For example, during squat training, it is important to perform training properly while keeping a correct posture, and it is desirable that the subject performs training while a caregiver is checking the subject's posture. Further, for example, during jump training, the subject practices to land with a correct posture so as to learn to perform a jump that has a lower possibility of damaging his/her ligaments. During jump training also, it is desirable that the subject performs training while a caregiver is watching and checking the subject's posture during the actual jump. As additional information, for example, it is known that, while playing sports such as skiing, basketball, soccer, and volleyball, ligaments are likely to be damaged by a motion of twisting a knee (i.e., a motion where the orientation of the knee comes inside of the orientation of the toe) when landing from a jump.

In the current situation, although the number of people who undergo rehabilitation will increase in the future from the standpoint of preventive medicine and sports medicine, the number of caregivers who aid the rehabilitation is significantly insufficient. To cope with this situation, the motion information processing apparatus 100 according to the first embodiment is configured to make it possible to easily and conveniently evaluate, for example, a gradual motion such as a motion of squat training or a quick motion such as a motion of jump training.

For example, the motion information processing apparatus 100 may be an information processing apparatus such as a computer, a workstation, or the like. As illustrated in FIG. 1, the motion information processing apparatus 100 includes an output unit 110, an input unit 120, a storage unit 130, and a controlling unit 140.

The output unit 110 is configured to output various types of information used for evaluating a gradual motion such as a squat motion or a quick motion such as a jump motion. For example, the output unit 110 displays a Graphical User Interface (GUI) used by an operator who operates the motion information processing apparatus 100 when inputting various types of requests through the input unit 120, displays display information generated by the motion information processing apparatus 100, or outputs a warning sound. For example, the output unit 110 may be configured by using a monitor, a speaker, headphones, or the headphone portion of a headset. Further, the output unit 110 may be configured by using a display device that is designed to be attached to the body of the user, e.g., a goggle-type display device or a head-mount display device.

The input unit 120 is configured to receive an input of the various types of information used for evaluating a gradual motion such as a squat motion or a quick motion such as a jump motion. For example, the input unit 120 receives inputs of various types of requests (e.g., a request indicating that a predetermined threshold value used for evaluating the gradual motion or the quick motion should be set; a request indicating that an evaluating process should be started; a request indicating that a selection should be made from various types of information; and a request indicating that a measuring process should be performed using the GUI) from the operator of the motion information processing apparatus 100 and transfers the received various types of requests to the motion information processing apparatus 100. For example, the input unit 120 may be configured by using a mouse, a keyboard, a touch command screen, a trackball, a microphone, or the microphone portion of a headset. Alternatively, the input unit 120 may be a sensor configured to obtain biological information such as a blood pressure monitor, a heart rate monitor, a clinical thermometer, or the like.

The storage unit 130 is a semiconductor memory element, such as a random access memory (RAM) and a flash memory, or a storage device, such as a hard disk device and an optical disk device, for example. The control unit 140 is provided by an integrated circuit, such as an application specific integrated circuit (ASIC) and a field programmable gate array (FPGA), or a central processing unit (CPU) executing a predetermined computer program.

A configuration of the motion information processing apparatus 100 according to the first embodiment has thus been explained. The motion information processing apparatus 100 according to the first embodiment configured as described above easily and conveniently evaluates the motion of at least one of a squat and a jump, by using a configuration explained in detail below. More specifically, the motion information processing apparatus 100 of the present disclosure includes an obtaining unit, a judging unit, and a controlling unit. The obtaining unit is configured to obtain motion information of a subject who performs a motion of at least one of a squat and a jump. The judging unit is configured to, on the basis of predetermined conditions for the motion of at least one of the squat and the jump, judge whether the motion of the subject indicated by the motion information obtained by the obtaining unit satisfies a certain condition included in the predetermined conditions. The controlling unit is configured to exercise control so that a judgment result obtained by the judging unit is provided as a notification. With this configuration, the motion information processing apparatus 100 easily and conveniently evaluates a gradual motion such as a squat or a quick motion such as a jump. In the description of exemplary embodiments below, the first to the third embodiments will be explained by using examples where squat training is performed as a gradual motion, whereas the fourth to the sixth embodiments will be explained by using examples where jump training is performed as a quick motion.

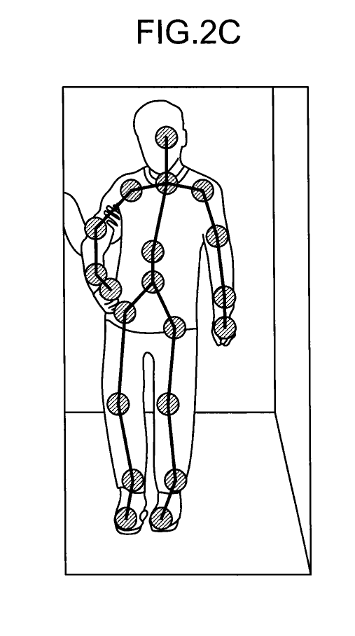

FIG. 4 is a diagram of an exemplary detailed configuration of the motion information processing apparatus 100 according to the first embodiment. First, details of the storage unit 130 included in the motion information processing apparatus 100 will be explained. As illustrated in FIG. 4, in the motion information processing apparatus 100, for example, the storage unit 130 includes a motion information storage unit 131 and a setting information storage unit 132.

The motion information storage unit 131 is configured to store therein the various types of information acquired by the motion information acquiring unit 10. More specifically, the motion information storage unit 131 stores therein the motion information generated by the motion information generating unit 14. Even more specifically, the motion information storage unit 131 stores therein the skeleton information corresponding to each of the frames generated by the motion information generating unit 14. In this situation, the motion information storage unit 131 may further store therein the color image information, the distance image information, and the speech recognition result that are output by the motion information generating unit 14, while keeping these pieces of information in correspondence with each of the frames.

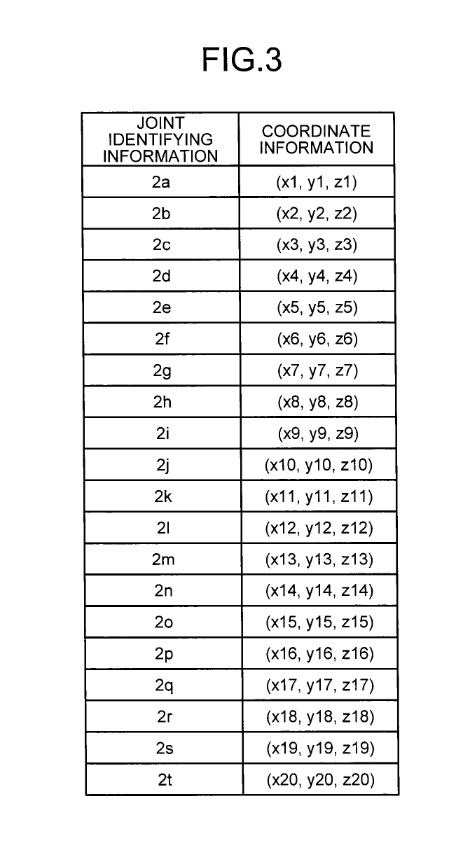

FIG. 5 is a table of examples of the motion information stored in the motion information storage unit 131 according to the first embodiment. As illustrated in FIG. 5, the motion information storage unit 131 stores therein motion information in which, for each of the names, a name number, the date of training, and pieces of motion information are kept in correspondence with one another. In this situation, the “name number” is an identifier used for uniquely identifying the subject and is provided for each name. The “date of training” indicates the date on which the subject performed the squat training. The “motion information” represents the information acquired by the motion information acquiring unit 10.

For example, as illustrated in FIG. 5, the motion information storage unit 131 stores therein “Name: A; Name Number: 1; Date of Training: 20120801_{—}1; Motion Information: color image information, distance image information, speech recognition result, skeleton information, . . . ”. These pieces of information indicate that, as the motion information of the “first time” squat training performed by the person named “Name: A” of which the “Name Number” is “1” on “August 1st” in the year “2012”, motion information including “color image information”, “distance image information”, “speech recognition result”, and “skeleton information” is stored.

In this situation, in the motion information illustrated in FIG. 5, the “color image information”, the “distance image information”, the “speech recognition result”, and the “skeleton information” for each of all the frames that were taken during the squat training are stored in time-series order, while being kept in correspondence with the time.

Further, as illustrated in FIG. 5, the motion information storage unit 131 stores therein “Name: A; Name Number: 1; Date of Training: 20120801_{—}2; Motion Information: color image information, distance image information, speech recognition result, skeleton information, . . . ”. In other words, the motion information storage unit 131 stores therein, in the same manner, the motion information of the “second time” squat training performed by the person named “Name: A” on “August 1st” in the year “2012”.

Further, as illustrated in FIG. 5, the motion information storage unit 131 also stores therein motion information including “color image information”, “distance image information”, “speech recognition result”, and “skeleton information”, for the person identified as “Name: B; Name Number: 2”. As explained here, the motion information storage unit 131 stores therein the motion information of the squat training acquired for each of the subjects, while keeping the motion information in correspondence with each of the subjects. The motion information illustrated in FIG. 5 is merely an example. In other words, the motion information storage unit 131 may further store therein other information besides the “color image information”, the “distance image information”, the “speech recognition result”, and the “skeleton information” illustrated in FIG. 5, while keeping the information in correspondence with one another. Further, for example, if the motion information acquiring unit 10 did not include the speech recognition unit 13, the motion information storage unit 131 would store therein information that includes no speech recognition result.

Further, the “color image information” and the “distance image information” included in the motion information contain image data in a binary format such as Bitmap, a Joint Photographic Experts Group (JPEG) format, or the like, or contain a link to such image data or the like. Further, instead of the recognition information described above, the “speech recognition result” included in the motion information may be audio data itself or a link to the recognition information or the audio data.

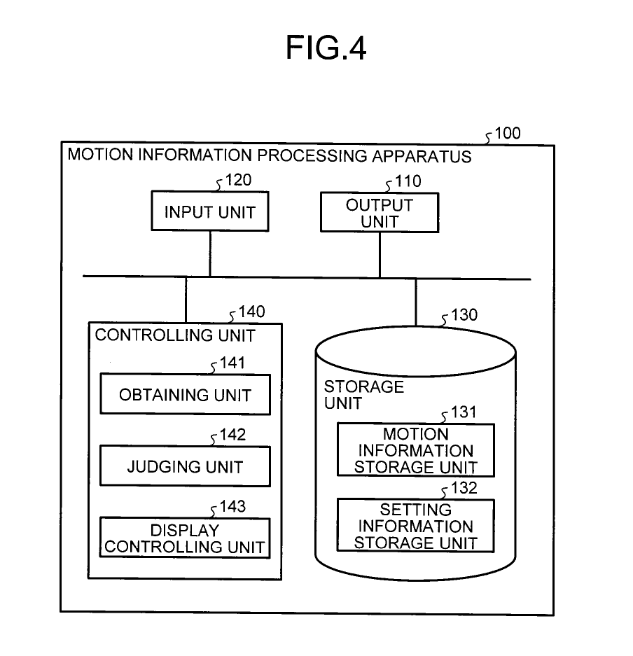

The setting information storage unit 132 is configured to store therein setting information used by the controlling unit 140 (explained later). More specifically, the setting information storage unit 132 stores therein the predetermined conditions used by the controlling unit 140 (explained later) for evaluating the gradual motion performed by a rehabilitation subject. For example, the setting information storage unit 132 stores therein a condition used for judging whether a squat performed by a subject is performed with a correct posture. Next, a correct posture for the rehabilitation squat training will be explained, with reference to FIG. 6.

FIG. 6 is a drawing for explaining postures of a subject during rehabilitation squat training according to the first embodiment. In FIG. 6, FIG. 6(A) illustrates a squat with a correct posture, whereas FIGS. 6(B) and 6(C) each illustrate a squat with an incorrect posture. For example, in the correct posture in the squat training, as illustrated in FIG. 6(A), the subject sticks the chest out while standing and bends the knees gradually to stick the buttocks out, while keeping the chest out. To have a correct posture during squat training, it is important to prevent the knees from projecting forward, while keeping the knees closed together in a knock-kneed state.

In other words, as illustrated in FIG. 6(B), a posture with the knees projecting forward is an incorrect posture for a squat. Also, as illustrated in FIG. 6(B), a posture with the heels off the ground is also an incorrect posture for a squat. Further, as illustrated in FIG. 6(C), even if the knees are not projecting forward, a posture with the subject's back hunched is also an incorrect posture for a squat.

Accordingly, the setting information storage unit 132 is configured to store therein various types of setting information used for evaluating a correct squat posture such as that illustrated in FIG. 6, for example. In one example, the setting information storage unit 132 stores therein, as predetermined conditions used when a squat is performed, setting information used for judging the following in a series of motions of the squat: how much the knees are projecting with respect to the positions of the ankles; how much the heels are off the ground; how much the arms are projecting rearward; and how much the upper body is leaning forward, and the like. Details of the setting information above will be explained more specifically later.

Next, details of the controlling unit 140 included in the motion information processing apparatus 100 will be explained. As illustrated in FIG. 4, in the motion information processing apparatus 100, for example, the controlling unit 140 includes an obtaining unit 141, a judging unit 142, and a display controlling unit 143.

The obtaining unit 141 is configured to obtain motion information of a subject who performs a gradual motion. More specifically, the obtaining unit 141 obtains the motion information acquired by the motion information acquiring unit 10 and stored in the motion information storage unit 131. For example, the obtaining unit 141 obtains the color image information, the distance image information, the speech recognition result, the skeleton information, and the like that are stored in the motion information storage unit 131 for each of the frames. In one example, the obtaining unit 141 obtains all the pieces of color image information, distance image information, and skeleton information that are related to a series of motions during the squat training of the subject.

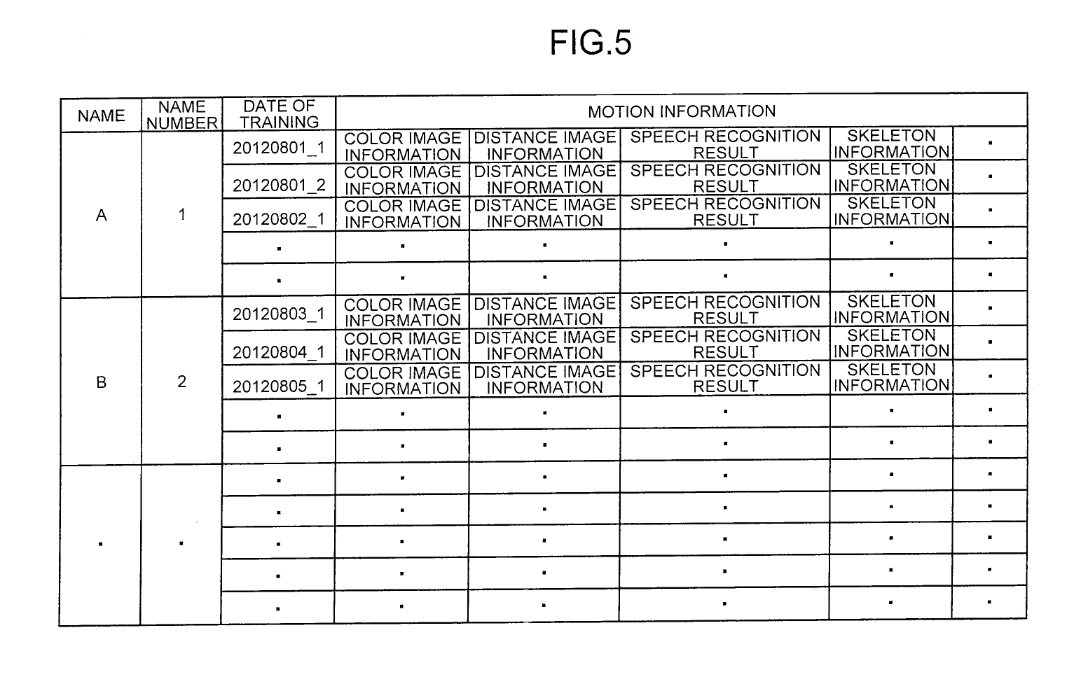

FIG. 7 is a drawing of an example of the skeleton information obtained by the obtaining unit 141 according to the first embodiment. FIG. 7 illustrates the example of the skeleton information of a subject who performs squat training. FIG. 7 illustrates an example in which the subject is positioned facing straight to the motion information acquiring unit 10. However, possible embodiments are not limited to this example. For instance, it is acceptable if the subject is positioned sideways to, at the back of, at an angle to, above, or beneath the motion information acquiring unit 10. In other words, the motion information acquiring unit 10 may be arranged in any position with respect to the subject. As illustrated in FIG. 7, for example, the obtaining unit 141 obtains the skeleton information of the subject who performs the squat training while being positioned facing straight to the motion information acquiring unit 10. In other words, the obtaining unit 141 acquires the skeleton information of all the frames acquired by the motion information acquiring unit 10.

On the basis of the predetermined conditions for the gradual motion, the judging unit 142 is configured to judge whether the motion of the subject indicated by the motion information obtained by the obtaining unit 141 satisfies a certain condition included in the predetermined conditions. More specifically, the judging unit 142 judges whether the skeleton information of the subject for each of the frames obtained by the obtaining unit 141 satisfies conditions of the setting information stored in the setting information storage unit 132. For example, on the basis of the predetermined conditions used when squat training is performed, the judging unit 142 judges whether the squat performed by the subject indicated by the skeleton information obtained by the obtaining unit 141 satisfies a certain condition included in the predetermined conditions stored in the setting information storage unit 132.

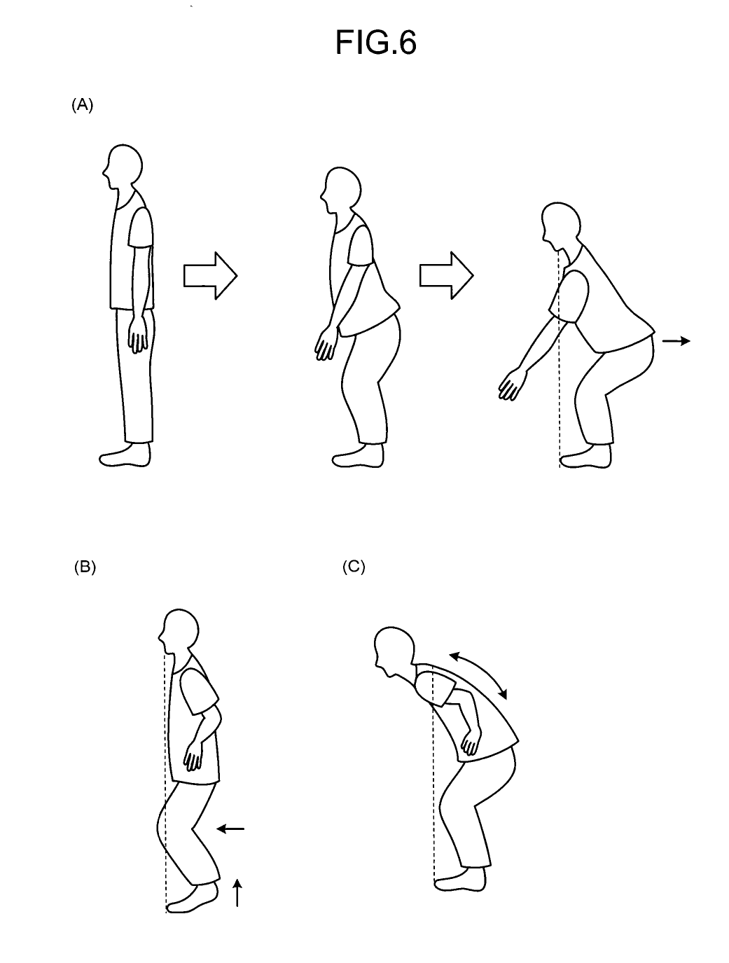

In one example, as the predetermined conditions used when squat training is performed, the judging unit 142 uses at least one of the following in a series of motions of the squat: how much the knees are projecting with respect to the positions of the ankles; how much the heels are off the ground; how much the arms are projecting rearward; and how much the upper body is leaning forward. FIG. 8A is a drawing for explaining an example of the squat training judging process performed by the judging unit 142 according to the first embodiment. FIG. 8A illustrates an example in which the judging unit 142 judges how much the knees are projecting with respect to the positions of the ankles. Also, FIG. 8A, illustrates the example in which the subject is performing the squat training while being positioned facing straight to the motion information acquiring unit 10.

For example, as illustrated in FIG. 8A, the judging unit 142 judges how much the knees are projecting (depth distances), by using coordinate information of the buttocks, the knees, and the ankles before the squat and during the squat. In other words, as illustrated in FIG. 8A, the judging unit 142 judges how much the knees are projecting, by judging whether a depth distance “d1” exceeds a predetermined threshold value, the depth distance “d1” being the distance between the joint “2n” corresponding to the right knee and the joint “2o” corresponding to the right ankle or the distance between the joint “2r” corresponding to the left knee and the joint “2s” corresponding to the left ankle. In the example illustrated in FIG. 8A, because the subject is performing the squat training while being positioned facing straight to the motion information acquiring unit 10, it is possible to calculate “d1=|z14−z15|”, when the depth distance “d1” is the distance between “2n (x14,y14,z14)” and “2o (x15,y15,z15)”. Alternatively, it is possible to calculate “d1=|z18−z19|”, when the depth distance “d1” is the distance between “2r (x18,y18,z18)” and “2s (x19,y19,z19)”. In other words, when the subject is positioned facing straight to the motion information acquiring unit 10, it is possible to calculate how much the knees are projecting with respect to the positions of the ankles, by calculating the difference between the z-axis coordinates of the two points.

The calculation using the difference between the z-axis coordinates of the two points described above is merely an example, and possible embodiments are not limited to this example. For instance, when the subject is positioned facing straight to the motion information acquiring unit 10, it is also acceptable to calculate the depth distance “d1” from a joint corresponding to a knee and a joint corresponding to a tarsus. Alternatively, it is also acceptable to calculate the depth distance “d1” from a joint corresponding to a knee and another position of a foot. Further, for example, depending on the orientation of the subject with respect to the motion information acquiring unit 10, the judging unit 142 may judge how much the knees are projecting, by using not only z-axis coordinates, but also x-axis coordinates and/or y-axis coordinates.

In this situation, the length of “d1” may arbitrarily be set by the user (e.g., the subject, a caregiver, or the like). In one example, the length of “d1” may arbitrarily be set according to the age and the gender of the subject, whether the rehabilitation is performed after injury treatment or the rehabilitation is performed from the standpoint of preventive medicine or sports medicine. In this situation, the length of “d1” may be set as an absolute position or a relative position. In other words, “d1” may simply be set as a length from the position of an ankle to the position of a knee or may be set as a length to a position relative to a position of correct squat training. The various types of information used in the judging process described above are stored as the setting information in the setting information storage unit 132. In other words, the judging unit 142 reads the setting information from the setting information storage unit 132 and performs the judging process.

Further, the judging unit 142 further judges whether the subject is performing the gradual motion. If it has been determined that the subject is performing the gradual motion, the judging unit 142 judges whether the motion of the subject indicated by the motion information obtained by the obtaining unit 141 satisfies the certain condition included in the predetermined conditions. For example, the judging unit 142 first judges whether the subject is performing squat training and, if it has been determined that the subject is performing squat training, the judging unit 142 judges whether the performed squat training is performed with a correct posture.

FIG. 8B is a drawing for explaining an example of a judging process performed by the judging unit 142 according to the first embodiment to judge whether squat training is performed. For example, as illustrated in FIG. 8B, the judging unit 142 determines that the subject is performing squat training, when the y coordinate “y1” of “2a” corresponding to a joint of the head of the subject or the y coordinate “y2” of “2b” corresponding to a joint at a center part of the two shoulders is lower than a predetermined threshold value “a” in the height direction (the vertical direction). After that, the judging unit 142 performs the squat training evaluation as illustrated in FIG. 8A. The example illustrated in FIG. 8B is merely an example, and possible embodiments are not limited to this example. In other words, the judging process to judge whether the subject is performing squat training or not does not necessarily have to be realized in the manner illustrated in FIG. 8B. For example, it is acceptable to determine that the subject is performing squat training when a predetermined time period has elapsed since the positions of the two ankles stop moving. In other words, it is acceptable to judge whether the subject is performing squat training by judging whether the subject has stopped moving motions and has completed a preparation to perform the squat training. The information used in the judging process described above is stored as the setting information in the setting information storage unit 132.

In addition, by using the motion information of the subject who performs the gradual motion obtained by the obtaining unit 141, the judging unit 142 is capable of calculating other various types of information besides the distance between the joints. More specifically, the judging unit 142 is capable of calculating an angle of joints, a speed, acceleration, and the like. After that, the judging unit 142 judges whether the gradual motion (e.g., the squat training) is correct or not by using the calculated various types of information. Further, the judging unit 142 is capable of performing the judging process not only in a real-time manner while the subject is performing the squat training, but also by reading the motion information from the past, for example.

In that situation, for example, the subject himself/herself or an operator (e.g., a medical doctor or a physiotherapist) inputs an instruction request for a judging process via the input unit 120. In that situation, the operator causes the obtaining unit 141 to obtain desired piece of motion information by inputting the name of a subject, a name number, a date of training, and the like. The obtaining unit 141 obtains a corresponding piece of motion information of the subject for which the request was received via the input unit 120, from the motion information storage unit 131. When the process is performed in a real-time manner while the squat training is being performed, it is also acceptable to configure the motion information to be automatically obtained without receiving an operation from the operator.

Returning to the description of FIG. 4, the display controlling unit 143 is configured to exercise control so that a judgment result obtained by the judging unit 142 is provided as a notification. More specifically, when the judging unit 142 has determined that the squat performed by the subject does not satisfy the certain condition included in the predetermined conditions, the display controlling unit 143 exercises control so that a warning is issued. Further, the display controlling unit 143 exercises control so that the output unit 110 displays various types of information related to an evaluation of the gradual motion including the squat training.

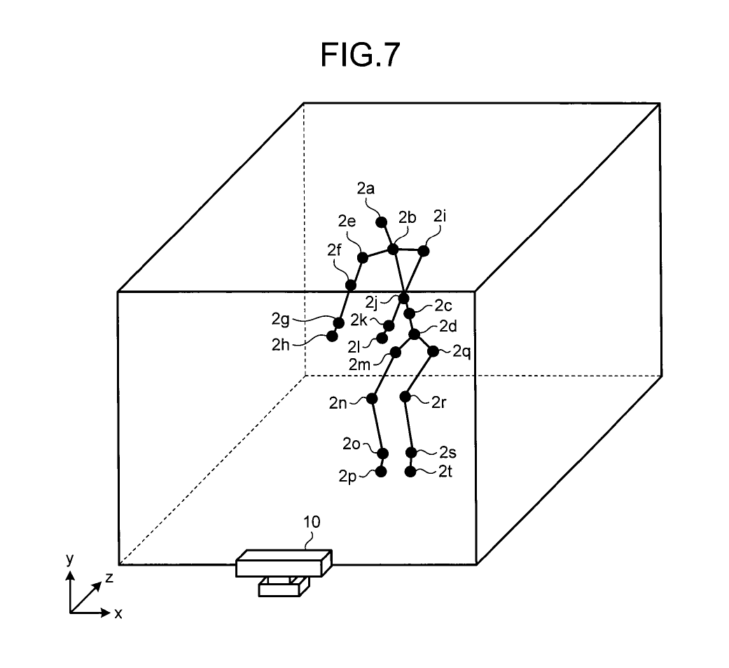

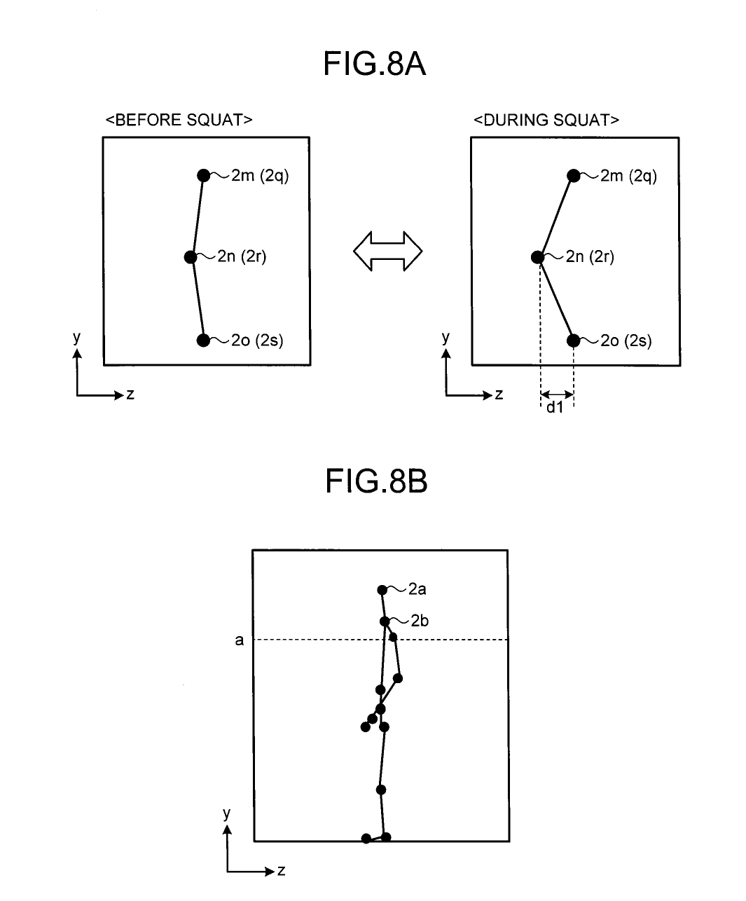

Next, examples of displayed contents displayed by the display controlling unit 143 will be explained, with reference to FIGS. 10 to 12. FIGS. 9 to 12 are drawings of examples of displayed contents on which display control is exercised by the display controlling unit 143 according to the first embodiment. For example, as illustrated in FIG. 9, the display controlling unit 143 causes the output unit 110 to display, as a squat training evaluation aiding function window, a Graphical User Interface (GUI) including a display region R1 for displaying the color image information of the subject and a display region R2 for displaying various types of information related to a squat evaluating process.

In this situation, as illustrated in the display region R1 in FIG. 9, the display controlling unit 143 causes a superimposed image to be displayed in which positions of joints and lines connecting the joints are superimposed on a color image of the subject. As a result, a viewer who views the output unit 110 is able to clearly observe movements of different sites of the subject. Further, as illustrated in the display region R2 in FIG. 9, the display controlling unit 143 displays a switch button used for switching on and off the function of evaluating the squat training of the subject, a checkbox used for turning the squat judging function on, a box for inputting a threshold value, a setting button for setting the threshold value, and measured results.

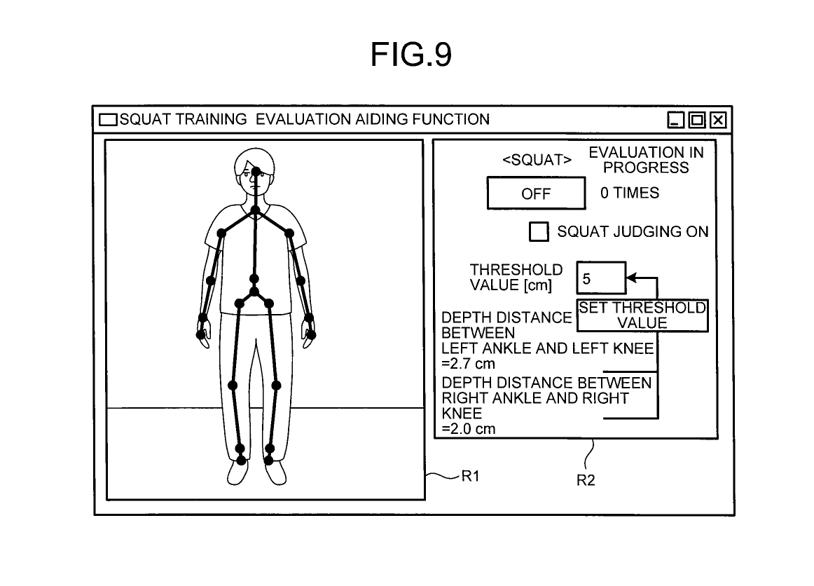

Next, an example of a series of processes during a squat training evaluation will be explained, with reference to FIGS. 10 and 11. For example, when a subject is to perform squat training, when an application having a squat training evaluation aiding function is activated via the input unit 120 of the motion information processing apparatus 100, the squat training evaluation aiding function window illustrated in FIG. 10(A) is displayed on the output unit 110. In this situation, in conjunction with the activation of the application, the motion information processing apparatus 100 sets the camera up-and-down angle of the motion information acquiring unit 10 to “0 degrees”. As a result, it is possible to utilize the coordinates in the depth direction (the degree of depth), without having to make a correction. When the camera up-and-down angle of the motion information acquiring unit 10 is not set to “0 degrees”, the coordinates in the depth direction are corrected on the basis of the current angle of the camera.

Further, as illustrated in FIG. 10(A), the subject stands so as to be positioned facing straight to the camera of the motion information acquiring unit 10 and performs squat training. In this situation, the motion information processing apparatus 100 may be configured to start the squat training evaluation at the same time as the application is activated or may be configured to receive an instruction to start the evaluation. For example, the subject may start the evaluation process by pressing, with the use of a mouse or the like, the switch button illustrated in FIG. 10(A) used for switching on and off the squat training evaluation function.

In other words, when the subject presses the “ON” button illustrated in FIG. 10(A), the motion information processing apparatus 100 displays the text “evaluation in progress” as illustrated in FIG. 10(B) and starts the squat training evaluation. In this situation, if the checkbox used for turning on the squat judging function displayed in the display region R2 is checked as illustrated in FIG. 10(B), the motion information processing apparatus 100 first judges whether the subject is performing a squat motion, and if it has been determined that the subject is performing a squat motion, the motion information processing apparatus 100 performs the evaluation while the squat motion is being performed.

In other words, on the basis of the motion information acquired by the motion information acquiring unit 10, the judging unit 142 judges whether the subject is performing squat training, by performing the judging process illustrated in FIG. 8B, for example. After that, if it has been determined that the subject is performing squat training, the judging unit 142 further performs the squat training evaluation by performing the judging process illustrated in FIG. 8A, for example.

In this situation, the predetermined threshold value related to the conditions of the setting information used for evaluating the squat training is arbitrarily set. For example, as illustrated in FIG. 10(B), the judging unit 142 performs a threshold value (centimeters [cm]) judging process on the depth distance between the left ankle and the left knee and the depth distance between the right ankle and the right knee. In this situation, as illustrated in FIG. 10(B), when a numerical value “8” is directly input in the threshold value (cm) box, the judging unit 142 judges whether the depth distance between the left ankle and the left knee or the depth distance between the right ankle and the right knee exceeds “8 cm” or not.

In other words, the judging unit 142 calculates the depth distance between the left ankle and the left knee and the depth distance between the right ankle and the right knee for each of all the frames acquired by the motion information acquiring unit 10 and judges whether each of the distances exceeds “8 cm” or not. For example, as illustrated in FIG. 10(B), if the depth distance between the left ankle and the left knee is “5.9 cm” and the depth distance between the right ankle and the right knee is “5.0 cm”, the judging unit 142 determines that the condition for the squat training is satisfied.

In contrast, as illustrated in FIG. 11, if the depth distance between the left ankle and the left knee is “12.9 cm” and the depth distance between the right ankle and the right knee is “12.0 cm”, the judging unit 142 determines that the condition for the squat training is not satisfied. In that situation, as illustrated in FIG. 11, for example, the display controlling unit 143 implements a warning display to cause a predetermined color to be displayed on the color image in a superimposed manner. After that, the display controlling unit 143 displays “1 time” as the number of times the condition was not satisfied, as illustrated in FIG. 11.

As explained above, the judging unit 142 may perform the judging process on the basis of the absolute positions of the sites of the subject, by using the directly-input value as the threshold value. However, the judging unit 142 may also perform a judging process on the basis of relative positions. For example, the judging unit 142 may perform a judging process by setting a state of the subject satisfying a predetermined condition as a reference state and comparing the difference from the reference state with a threshold value. In one example, while the subject is performing a squat (e.g., bending his/her knees) that satisfies the condition, the threshold value setting button included in the display region R2 is pressed. With this arrangement, the motion information processing apparatus 100 evaluates the squat training by using the state as a reference state and judging how much the squats performed thereafter deviate from the reference state. The tolerance amount for deviations from the reference state may arbitrarily be set.

Further, FIG. 11 illustrates the example in which the warning display is implemented on the color image. However, possible embodiments are not limited to this example. For instance, a warning sound may be output or a warning text may be displayed. In that situation, the controlling unit 140 exercises control so that the warning sound is output from the output unit 110 or the display controlling unit 143 exercises control so that the warning text is displayed.

The display examples illustrated in FIGS. 9 to 11 are merely examples. The display controlling unit 143 is capable of causing other various types of information to be displayed as the display information. For example, the display controlling unit 143 may exercise control so that the total count of squat motions is displayed. In one example, the display controlling unit 143 is capable of causing information to be displayed such as “the number of times the condition was not satisfied/the total squat count” together with the text “1 time” displayed as the number of times the condition was not satisfied illustrated in FIG. 11. In that situation, when the judging unit 142 has determined that the subject is performing a squat motion, the display controlling unit 143 increments the total squat count.

Further, FIGS. 9 to 11 illustrate the example in which, when the squat motion performed by the subject does not satisfy the condition, the warning is issued, so that the number of times a waning is issued is counted. However, possible embodiments are not limited to this example. For instance, another arrangement is acceptable in which, when the squat motion performed by the subject satisfies the condition, information indicating that the motion is normal is provided as a notification so that the number of times a normal motion is performed is counted. In that situation, for example, when the judging unit 142 has determined that a squat performed by the subject satisfies the certain condition included in the predetermined conditions, the display controlling unit 143 notifies that the motion is normal (e.g., displays a circle on the screen) and increments the count for the number of times a normal motion is performed that is displayed on the screen.

The examples of the displayed contents displayed under the control of the display controlling unit 143 have thus been explained. The examples described above are merely examples. The display controlling unit 143 is capable of causing various types of displayed contents to be displayed. For instance, in the description above, the example in which the subject is a single person is explained; however, there may be two or more subjects.

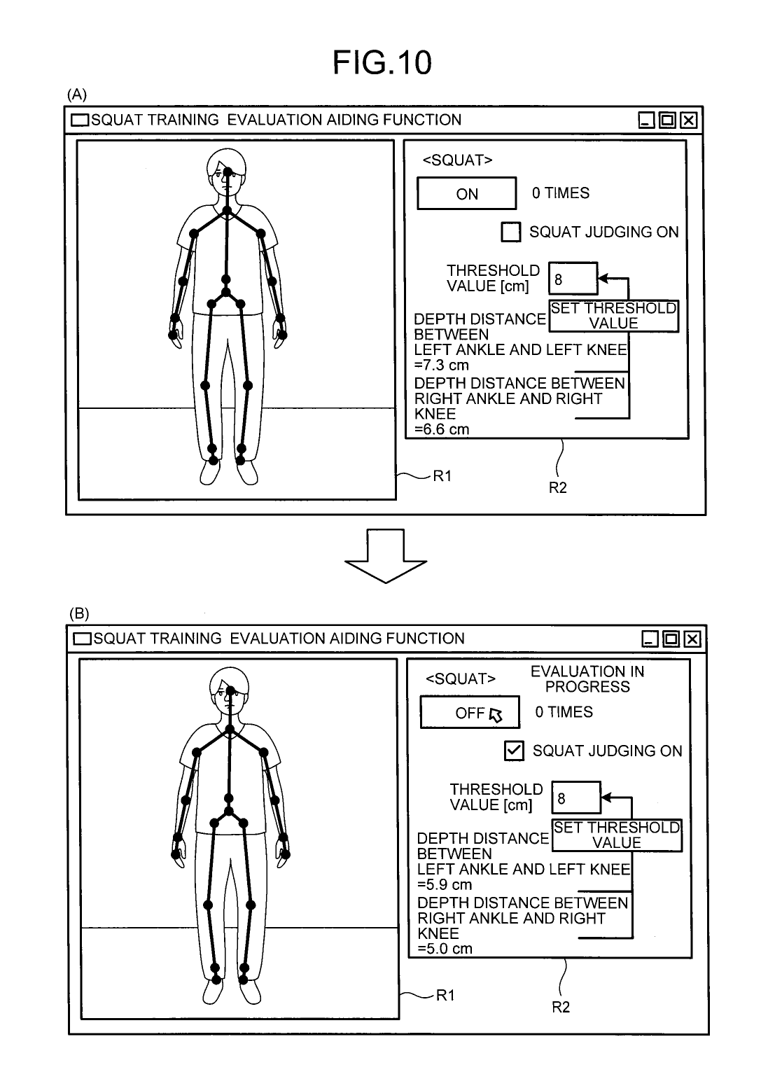

For example, as illustrated in FIG. 12, the display controlling unit 143 causes color images of a squat subject 1 and a squat subject 2 to be displayed in the window of the squat training evaluation aiding function. After that, as illustrated in FIG. 12, the display controlling unit 143 causes text to be displayed between the color images so as to read “evaluation”, “total count”, “number of times of warning”, “depth distance between left ankle and left knee”, and “depth distance between right ankle and right knee” and causes an evaluation start button to be displayed underneath. The display example illustrated in FIG. 12 is merely an example, and possible embodiments are not limited to this example. In other words, the display controlling unit 143 is capable of further causing other information to be displayed that is different from the information illustrated in the drawing. The display controlling unit 143 is also capable of exercising control so that the information illustrated in the drawing is not displayed. In one example, the display controlling unit 143 is capable of exercising control so that the “depth distance between the left ankle and the left knee” and the “depth distance between the right ankle and the right knee” are not displayed.

In this situation, the evaluation start button illustrated in FIG. 12 is an ON/OFF button that is used in common for both of the subjects as illustrated in FIG. 12. When the “ON” button is pressed, a measuring process for both of the subjects is started. When the “OFF” button is pressed, the measuring process for both of the subjects is ended. For example, while the squat subject 1 and the squat subject 2 are standing so as to be positioned facing straight to the motion information acquiring unit 10, when the ON/OFF button is pressed, the motion information acquiring unit 10 acquires motion information of both of the subjects. The display controlling unit 143 is also capable of exercising control so that, when the OFF button is pressed, the count values for the “total count” and “number of times of warning” are initialized (reset) to “0”.

The obtaining unit 141 obtains the motion information for each of all the frames of both of the subjects and sends the obtained motion information to the judging unit 142. On the basis of the motion information obtained by the obtaining unit 141, the judging unit 142 judges the squat training of the squat subject 1 and the squat subject 2. The display controlling unit 143 displays judgment results of the squat training of the squat subject 1 and the squat subject 2 obtained by the judging unit 142. In this situation, as illustrated in FIG. 12, the display controlling unit 143 may display “Good!!” or “Bad . . . ” as evaluation results. The evaluation results may be obtained by comparing the numbers of times a warning was issued between the two subjects so that the subject having the smaller count is displayed with “Good!!”, while the other subject having the larger count is displayed with “Bad . . . ”. Alternatively, “Good!!” may be displayed when the number of times a warning was issued is less than 3, and “Bad . . . ” may be displayed when the number of times a warning was issued is 5 or more.

In the exemplary embodiment described above, the example is explained in which the squat training is evaluated in a real-time manner, while the squat training is being performed. However, possible embodiments are not limited to this example. For instance, squat training may be evaluated by using the motion information of squat training that was performed in the past.

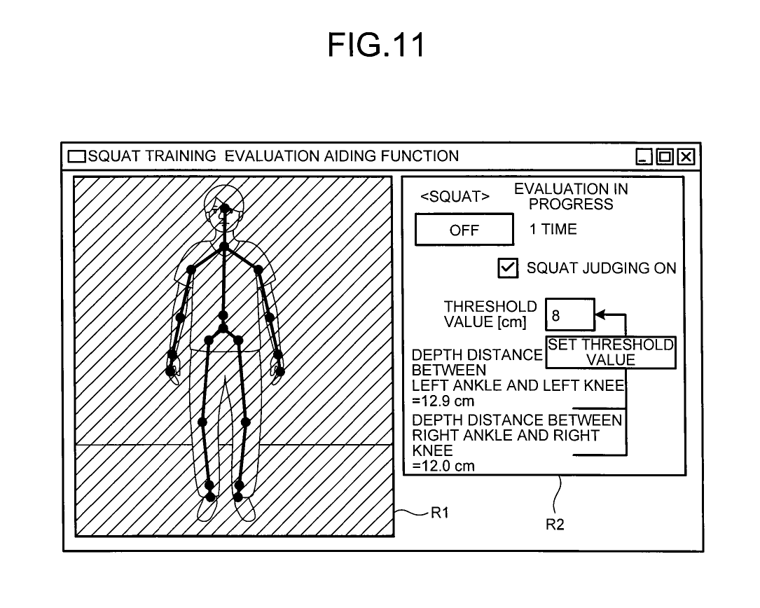

Next, a process performed by the motion information processing apparatus 100 according to the first embodiment will be explained, with reference to FIG. 13. FIG. 13 is a flowchart of a procedure in the process performed by the motion information processing apparatus 100 according to the first embodiment. FIG. 13 illustrates an example in which the evaluation is performed in a real-time manner. Further, FIG. 13 illustrates an example in which the evaluation function can be switched on and off by using the evaluation start button.

As illustrated in FIG. 13, in the motion information processing apparatus 100 according to the first embodiment, when a subject who is to perform squat training appears in front of the motion information acquiring unit 10, the obtaining unit 141 obtains motion information of the subject (step S101). After that, when the evaluation start button to start a squat evaluation is pressed, the judging unit 142 judges whether the evaluation function is on (step S102).

If the evaluation function is on (step S102: Yes), the judging unit 142 judges whether the subject is performing a squat (step S103). If the subject is performing a squat (step S103: Yes), the judging unit 142 extracts coordinate information of relevant sites (e.g., the ankles and the knees) (step S104), calculates the distances (step S105), and judges whether the threshold value is exceeded (step S106).

If at least one of the distances exceeds the threshold value (step S106: Yes), the display controlling unit 143 displays a warning (step S107), and judges whether an instruction to turn off the evaluation function is received (step S108). On the contrary, if the threshold value is not exceeded (step S106: No), the display controlling unit 143 judges whether an instruction to turn off the evaluation function is received (step S108).

If an instruction to turn off the evaluation function is received (step S108: Yes), the motion information processing apparatus 100 resets the count values of the number of times of warning and the total count to indicate “0” times (step S109), and the process is ended. On the contrary, if no instruction to turn off the evaluation function is received (step S108: No), the process returns to step S101 so that the motion information processing apparatus 100 continues to obtain motion information of the subject. Also, when the evaluation function is off (step S102: No) or when the subject is not performing a squat (step S103: No), the process returns to step S101, so that the motion information processing apparatus 100 continues to obtain motion information of the subject.

The procedure in the process is described above using the example in which it is judged whether the subject is performing a squat (when the squat judging function is on). However, the motion information processing apparatus 100 according to the first embodiment may also perform an evaluation even if the squat judging function is off. In that situation, during the procedure in the process illustrated in FIG. 13, if the evaluation function is on at step S102, the process at step S104 is performed to extract the coordinate information of the relevant sites, without performing the process at step S103 to judge whether the subject is performing a squat.

As explained above, according to the first embodiment, the obtaining unit 141 obtains the motion information of the subject who performs the squat motion. On the basis of the predetermined conditions for the squat motion, the judging unit 142 judges whether the motion of the subject indicated by the motion information obtained by the obtaining unit 141 satisfies the certain condition included in the predetermined conditions. The controlling unit 140 exercises control so that the judgment result obtained by the judging unit 142 is provided as the notification. Accordingly, the motion information processing apparatus 100 according to the first embodiment is able to evaluate the squat motion, by only having the subject perform the squat motion in front of the motion information acquiring unit 10. The motion information processing apparatus 100 thus makes it possible to easily and conveniently evaluate the squat motion.

As a result, for example, even when the subject undergoes rehabilitation by himself/herself, the motion information processing apparatus 100 is able to prompt the subject to undergo the rehabilitation with a correct posture. Thus, the motion information processing apparatus 100 is able to compensate for a shortage of caregivers and makes it possible for the subject to undergo rehabilitation that is better than a certain level, without being conditioned by the level of skills of the caregiver.

Further, according to the first embodiment, the controlling unit 140 exercises control so as to notify that the motion is normal, when the judging unit 142 has determined that the squat performed by the subject satisfies the certain condition included in the predetermined conditions and so that the warning is issued when the judging unit 142 has determined that the squat performed by the subject does not satisfy the certain condition included in the predetermined conditions. Consequently, the motion information processing apparatus 100 according to the first embodiment makes it possible to easily and conveniently evaluate the squat training, which is considered important from the standpoint of preventive medicine and sports medicine.

Further, according to the first embodiment, the judging unit 142 uses how much the knee is projecting with respect to the position of the ankle in the series of motions of a squat, as the predetermined condition used when a squat is performed. Consequently, the motion information processing apparatus 100 according to the first embodiment is able to perform the evaluation on the basis of the important motion among the series of motions of a squat and thus makes it possible to prompt the subject to have a more correct posture.

Further, according to the first embodiment, the judging unit 142 further judges whether the subject is performing a squat motion and, if it has been determined that the subject is performing a squat motion, the judging unit 142 judges whether the motion of the subject indicated by the motion information obtained by the obtaining unit 141 satisfies the certain condition included in the predetermined conditions. Consequently, the motion information processing apparatus 100 according to the first embodiment prevents the judging process from being performed on motions that are irrelevant to the motion being the target of the evaluation. The motion information processing apparatus 100 thus makes it possible to provide clearer judgment results.

Further, according to the first embodiment, with respect to the predetermined conditions used by the judging unit 142, the input unit 120 receives the input operation for setting the predetermined threshold value used for judging whether the certain condition is satisfied or not. Consequently, the motion information processing apparatus 100 according to the first embodiment is able to set a fine-tuned threshold value for each subject and thus makes it possible to easily and conveniently perform the evaluation properly.

Further, according to the first embodiment, the input unit 120 receives at least one of the threshold value for the absolute position and the threshold value for the relative position with respect to the predetermined conditions. Consequently, the motion information processing apparatus 100 according to the first embodiment makes it possible to easily and conveniently perform the evaluation in a flexible manner.

Further, according to the first embodiment, the input unit 120 further receives the input operation for starting the judging process performed by the judging unit 142. Consequently, the motion information processing apparatus 100 according to the first embodiment is able to prevent the evaluation from being automatically performed on motions irrelevant to the evaluation and is able to perform the evaluation only on the motion being the target of the evaluation. Thus, the motion information processing apparatus 100 makes it possible to provide clearer evaluation results.

### Second Embodiment

In the first embodiment described above, the example was explained in which the squat training is evaluated on the basis of the depth distance between the ankle and the knee. However, possible embodiments are not limited to this example. The squat training may be evaluated on the basis of other sites of the body. In a second embodiment, various judging processes performed on the basis of other sites of the body will be explained. The judging processes explained below may additionally be used together with the judging process that uses the depth distance between the ankle and the knee described in the first embodiment or may be used alone. The second embodiment is different from the first embodiment for the contents of the process performed by the judging unit 142. The second embodiment will be explained below while a focus is placed on the difference.

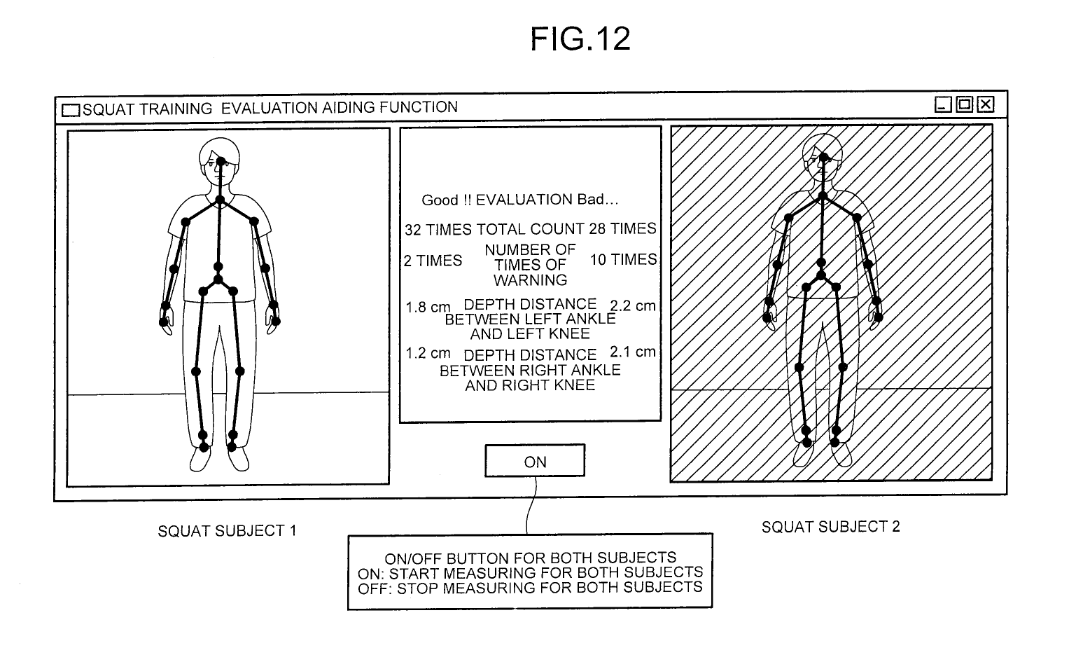

The judging unit 142 according to the second embodiment uses at least one of the following in a series of motions of a squat: how much the heels are off the ground; how much the arms are projecting rearward; and how much the upper body is leaning forward. FIGS. 14A to 14C are drawings for explaining examples of a squat training judging process performed by the judging unit 142 according to the second embodiment. FIG. 14A illustrates a judging process that uses how much the heels are off the ground. FIG. 14B illustrates a judging process that uses how much the arms are projecting rearward. FIG. 14C illustrates a judging process that uses how much the upper body is leaning forward. Further, FIGS. 14A to 14C illustrate examples in which the subject performs squat training while being positioned facing straight to the motion information acquiring unit 10.

For example, as illustrated in FIG. 14A, the judging unit 142 according to the second embodiment judges how much the heels are off the ground (distances in the height direction) by using coordinate information of the center of the buttocks, the buttocks (the pelvises), the knees, and the ankles before a squat and during the squat. In other words, as illustrated in FIG. 14A, the judging unit 142 judges how much the heels are off the ground by judging whether a height-direction distance “d2” exceeds a predetermined threshold value, the height-direction distance “d2” being the distance between the joint “2o” corresponding to the right ankle and the joint “2p” corresponding to the right tarsus or the distance between the joint “2s” corresponding to the left ankle and the joint “2t” corresponding to the left tarsus.

In this situation, it is possible to calculate “d2=|y15−y16|”, when the height-direction distance “d2” is the distance between “2o (x15,y15,z15)” and “2p (x16,y16,z16)”. Alternatively, it is possible to calculate “d2=|y19−y20|”, when the height-direction distance “d2” is the distance between “2s (x19,y19,z19)” and “2t (x20,y20,z20)”.

Further, for example, as illustrated in FIG. 14B, the judging unit 142 according to the second embodiment judges how much the arms are projecting rearward (depth distances) by using coordinate information of the shoulders, the elbows, and the wrists before a squat and during the squat. In other words, as illustrated in FIG. 14B, the judging unit 142 judges how much the arms are projecting rearward by judging whether a depth distance “d3” exceeds a predetermined threshold value, the depth distance “d3” being the distance between the joint “2i” corresponding to the left shoulder and the joint “2k” corresponding to the left wrist or the distance between the joint “2e” corresponding to the right shoulder and the joint “2g” corresponding to the right wrist.

In this situation, because the subject is positioned facing straight to the motion information acquiring unit 10, it is possible to calculate “d3=|z9−z11|”, when the depth distance “d3” is the distance between “2i (x9,y9,z9)” and “2k (x11,y11,z11)”. Alternatively, it is possible to calculate “d3=|y5−y7|”, when the depth distance “d3” is the distance between “2e (x5,y5,z5)” and “2g (x7,y7,z7)”. In other words, when the subject is positioned facing straight to the motion information acquiring unit 10, it is possible to calculate how much the arms are projecting rearward, by calculating the difference between the z-axis coordinates of the two points.

Further, for example, as illustrated in FIG. 14C, the judging unit 142 according to the second embodiment judges how much the upper body is leaning forward (a depth distance) by using coordinate information of the knees, the ankles, and the tarsi before a squat and during the squat. In other words, as illustrated in FIG. 14C, the judging unit 142 judges how much the upper body is leaning forward by judging whether a depth distance “d4” exceeds a predetermined threshold value, as well as the height-direction distance of the center of the buttocks is lower than a threshold value “b”, the depth distance “d4” being the distance between the joint “2d” corresponding to the center of the buttocks and the joint “2o” corresponding to the right ankle or the distance between the joint “2d” corresponding to the center of the buttocks and the joint “2s” corresponding to the left ankle.

In this situation, because the subject is positioned facing straight to the motion information acquiring unit 10, it is possible to calculate “d4=|z15−z4|”, when the depth distance “d4” is the distance between “2d (x4,y4,z4)” and “2o (x15,y15,z15)”. Alternatively, it is possible to calculate “d4=|z19−z4|”, when the depth distance “d4” is the distance between “2d (x4,y4,z4)” and “2s (x19,y19,z19)”. Further, the height-direction distance of the center of the buttocks is “y4”.

The lengths of the distances described above may arbitrarily be set by the user (e.g., the subject, a caregiver, or the like). In one example, the lengths of “d2”, “d3”, and “d4” and the length of the height-direction distance of the center of the buttocks may arbitrarily be set according to the age and the gender of the subject, whether the rehabilitation is performed after injury treatment or the rehabilitation is performed from the standpoint of preventive medicine or sports medicine. In this situation, the length of each of the distances may be set as an absolute position or a relative position, like in the first embodiment. The various types of information used in the judging process described above are stored as the setting information in the setting information storage unit 132. In other words, the judging unit 142 reads the setting information from the setting information storage unit 132 and performs the judging process.

The examples described above are merely examples, and possible embodiments are not limited to these examples. In other words, as the setting information used for evaluating the squat training, information other than the information illustrated in FIGS. 14A to 14C may be used. Further, the coordinate information used for evaluating each of the states does not necessarily have to be the coordinate information described above. Any other various types of coordinate information may be used. For example, it is acceptable to use the coordinates of the elbows and the wrists to judge how much the arms are projecting rearward.

The judging unit 142 according to the second embodiment evaluates the squat training by performing the various types of judging processes described above either each type alone or in combination as appropriate. Further, the display controlling unit 143 according to the second embodiment exercises control so as to notify that the motion is normal or so that the warning is issued, in accordance with the judgment result from the judging process.

As explained above, according to the second embodiment, as the predetermined conditions used when a squat is performed, the judging unit 142 uses at least one of the following in the series of motions of the squat: how much the heels are off the ground; how much the arms are projecting rearward; and how much the upper body is leaning forward. Consequently, the motion information processing apparatus 100 according to the second embodiment is able to evaluate the squat training on the basis of the entire motions of the subject who performs the squat training. The motion information processing apparatus 100 thus makes it possible to easily and conveniently evaluate the squat training with a high level of precision.

### Third Embodiment

The first and the second embodiments have thus been explained. The present disclosure may be carried out in other various modes besides the first and the second embodiments described above.

In the first and the second embodiments described above, the examples are explained in which the subject who performs the squat training is positioned facing straight to the motion information acquiring unit 10. However, possible embodiments are not limited to these examples. For instance, the present disclosure is applicable to situations where the subject is not positioned facing straight to the motion information acquiring unit 10 (i.e., the subject is not oriented in the depth direction).

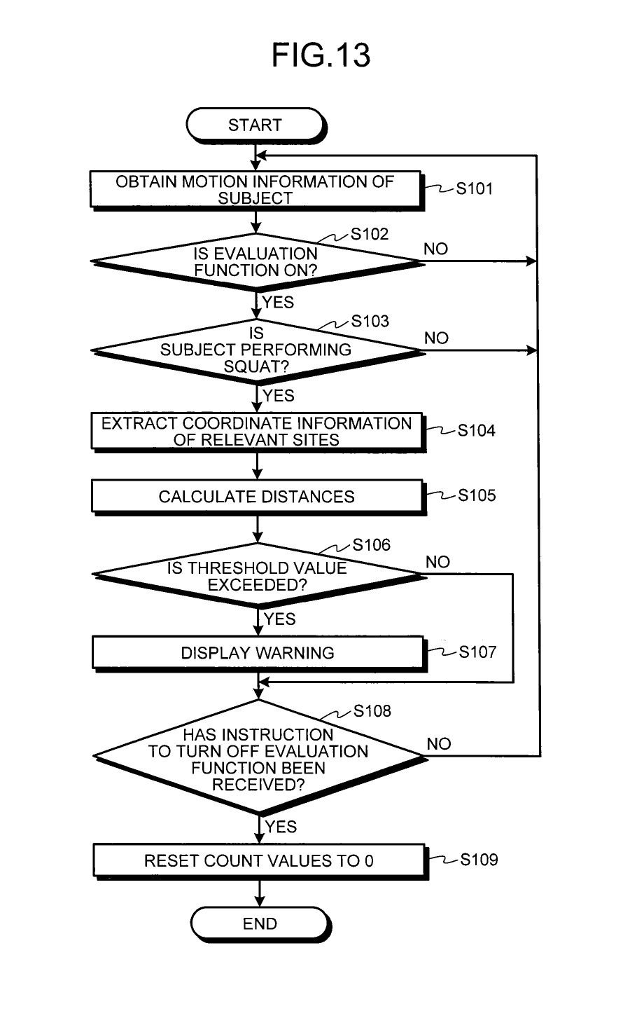

FIG. 15 is a drawing for explaining an example of a squat training judging process performed by a judging unit according to a third embodiment. FIG. 15 illustrates the example of the squat training judging process performed by the judging unit 142 when the subject is not oriented in the depth direction. For example, as illustrated in FIG. 15, the judging unit 142 judges how much the knees are projecting (the depth distances) by using three-dimensional coordinate information of the buttocks, the knees, and the ankles before a squat and during the squat. In other words, as illustrated in FIG. 15, the judging unit 142 judges how much the knees are projecting by judging whether a depth distance “d5” exceeds a predetermined threshold value, the depth distance “d5” being the distance between the joint “2n” corresponding to the right knee and the joint “2o” corresponding to the right ankle or the distance between the joint “2r” corresponding to the left knee and the joint “2s” corresponding to the left ankle.

In this situation, in the example illustrated in FIG. 15, because the subject is performing the squat training while not being positioned facing straight to the motion information acquiring unit 10, it is possible to calculate “d5=√{(x15−x14)²+(y15−y14)²+(z15−z14)²}×cos θ1”, when the depth distance “d5” is the distance between “2n (x14,y14,z14)” and “2o (x15,y15,z15)”. Alternatively, it is possible to calculate “d5=√{(x19−x18)²+(y19−y18)²+(z19−z18)²}×cos θ1”, when the depth distance “d5” is the distance between “2r (x18,y18,z18)” and “2s (x19,y19,z19)”. In other words, when the subject is not positioned facing straight to the motion information acquiring unit 10, the three-dimensional distance between the two points is calculated.

In this situation, the length of “d5” may arbitrarily be set by the user (e.g., the subject, a caregiver, or the like). In one example, the length of “d5” may arbitrarily be set according to the age and the gender of the subject, whether the rehabilitation is performed after injury treatment or the rehabilitation is performed from the standpoint of preventive medicine or sports medicine. In this situation, the length of “d5” may be set as an absolute position or a relative position, like in the examples described above. The various types of information used in the judging process described above are stored as the setting information in the setting information storage unit 132. In other words, the judging unit 142 reads the setting information from the setting information storage unit 132 and performs the judging process.

The above example is explained by using the situation where the depth distance “d5” is calculated on the basis of the three-dimensional distance between the two points when the subject is not positioned facing straight to the motion information acquiring unit 10. However, possible embodiments are not limited to this example. For instance, it is also acceptable to correct the coordinate information of joints as if the subject was positioned facing straight, by using a sagittal plane or a coronal plane of the subject and to calculate the depth distance on the basis of the corrected coordinate information. In that situation, for example, the judging unit 142 calculates a coronal plane of the subject from the coordinates of the joints corresponding to the head, the waist, and the two shoulders of the subject. After that, the judging unit 142 calculates the angle between the calculated coronal plane and the sensor surface of the motion information acquiring unit 10 and corrects the coordinate information of the joints by using the calculated angle. In other words, the judging unit 142 corrects the coordinate information of the joints so that the coronal plane and the sensor surface become parallel to each other and calculates the depth information by using the values of the z-axis coordinates of the corrected coordinate information. Further, the judging unit 142 may further calculate a sagittal plane by using information of the coronal plane and perform the judging process by using information of the calculated sagittal plane.

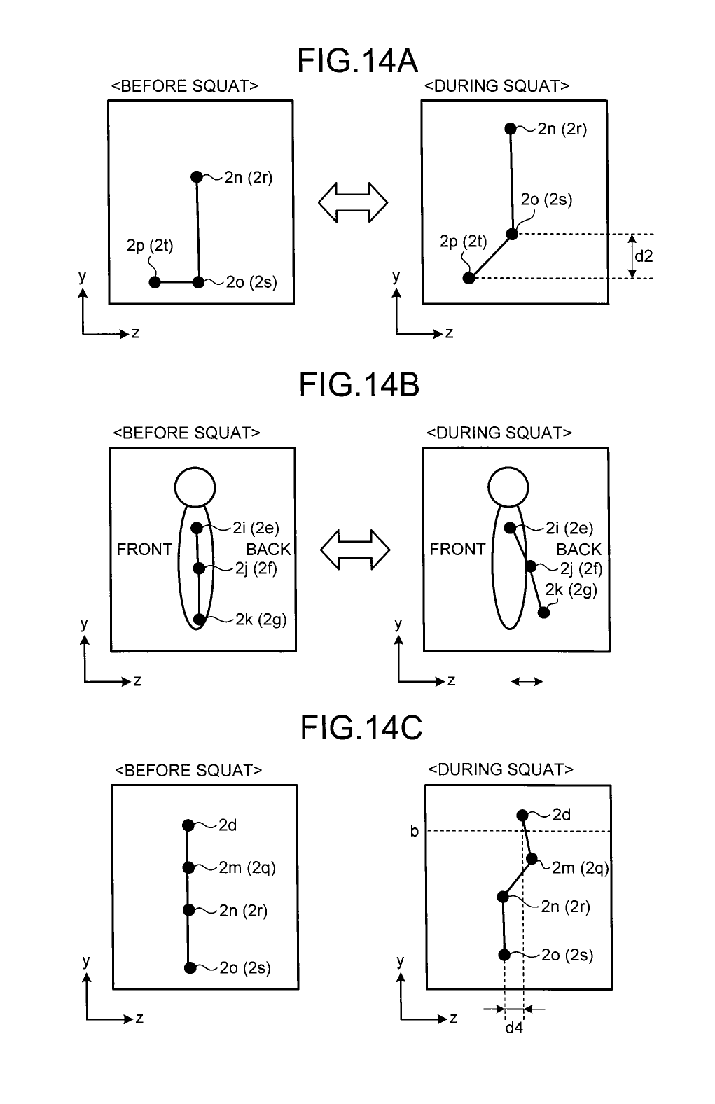

The above example is explained by using the situation where the squat training is evaluated by using the distance between the two points. However, possible embodiments are not limited to this example. For instance, the evaluation may be performed on the basis of the gravity point, angles, torsion of the body axis, and the position of the head of the subject, as well as the speed at which the training is performed, and the like. FIG. 16 is a drawing for explaining a modification example of the squat training judging process performed by the judging unit 142 according to the third embodiment. FIG. 16 illustrates an example in which angle information and position information are used for the squat training judging process.

For example, as illustrated in FIG. 16, the judging unit 142 judges how much the upper body is leaning, by calculating an angle “θ2” formed by a line connecting the joint “2b” corresponding to the center part of the two shoulders to the joint “2d” corresponding to the center of the buttocks and the vertical direction and judging if the calculated value of “θ2” exceeds a predetermined threshold value.

Alternatively, the judging unit 142 judges whether the waist is lowered properly, by judging whether the joint “2d” corresponding to the center of the buttocks alternates between a value smaller than a predetermined value “c” and a value larger than the predetermined value “c” during the squat training. The example illustrated in FIG. 16 is merely an example, and possible embodiments are not limited to this example.

In the first and the second embodiments described above, the example is explained in which the judging unit 142 judges whether the gradual motion (e.g., the squat training) is properly performed. However, possible embodiments are not limited to this example. For instance, it is acceptable to provide a prevention function to prevent a fall. For example, the judging unit 142 may judge whether the subject is likely to fall during a squat training judging process and may alert the user when the subject is likely to fall.

Next, an example of the fall prevention function will be explained. For example, the judging unit 142 judges how much the upper body is tilting rearward by judging whether the angle “θ2” illustrated in FIG. 16 exceeds a predetermined threshold value rearward. Further, when the judging unit 142 has determined that “θ2” has exceeded the predetermined threshold value rearward, the display controlling unit 143 alerts the user to be cautious about falling. For example, the display controlling unit 143 alerts the user by displaying in yellow at the point in time when “θ2” becomes equal to the predetermined threshold value rearward and by displaying in red at the point in time when “θ2” becomes equal to “the threshold value+α” (where α is an arbitrary value).

The example described above is merely an example, and the fall prevention function may be realized in any other embodiments. For example, the judging unit 142 may judge how much the upper body is tilting rearward by judging whether the frequency with which the height-direction coordinates of the right and left tarsi become higher than the height-direction coordinates of the ankles exceeds a predetermined level of frequency.

In the first and the second embodiments described above, the example is explained in which the prescribed joints (e.g., the tarsi, the ankles, the knees, and the like) are used as the coordinates used for evaluating the gradual motion (e.g., the squat training). However, possible embodiments are not limited to this example. For instance, it is acceptable to evaluate a gradual motion (e.g., squat training) by using coordinates of a position that is set between predetermined joints.

In the first and the second embodiments described above, the squat training is used as a targeted gradual motion. However, possible embodiments are not limited to this example. For instance, shoulder flexion (e.g., raising arms forward) in joint range-of-motion training or push-up or sit-up exercise in sports medicine may be used as a targeted motion. In that situation, setting information is stored for each targeted motion, so that each motion is evaluated by using various types of threshold values.

As explained above, the motion information processing apparatus 100 of the present disclosure makes it possible to easily and conveniently evaluate the gradual motion. Consequently, the subject is able to use the motion information processing apparatus 100 safely, easily, and conveniently, even in a clinic or an assembly hall where few caregivers are available. Further, for example, it is also possible to improve motivation of subjects by saving data of each of the subjects in the motion information processing apparatus 100 and making the data public in a ranking format.

In that situation, for example, the storage unit 130 stores therein the number of times a warning was issued for each of the subjects so that the results are displayed in a ranking format in ascending order of the number of times of warning, either regularly or in response to a publication request from a subject. Further, the subjects may be listed in a ranking format in smaller categories according to the gender, the age, and the like of the subjects, for each of different types of motions.

In the first and the second embodiments described above, the example is explained in which the squat training is performed as the rehabilitation functional training. However, possible embodiments are not limited to this example. For instance, the present disclosure is applicable to a situation where a sports athlete or the like performs a squat as part of his/her training. In that situation, for example, the motion information processing apparatus 100 is installed in a training gym or the like so that the subject who performs a squat performs the squat training while using the motion information processing apparatus 100.

The first and the second embodiments above are explained using the example in which the operator switches on and off the judging function via the input unit 120. However, possible embodiments are not limited to this example. For instance, the judging function may be switched on and off as being triggered by a predetermined motion of the subject. In that situation, for example, the judging unit 142 starts and ends the process of judging whether the motion of the subject indicated by the motion information obtained by the obtaining unit 141 satisfies the certain condition included in the predetermined conditions, on the basis of the predetermined motion of the subject. With this arrangement, for example, the subject is able to switch on and off at a start and an end of the judging process by simply performing the predetermined motion in front of the motion information acquiring unit 10. Thus, even if the subject is by himself/herself, he/she is able to have the squat training evaluated easily.

In the first to the third embodiments above, the examples in which the squat training is evaluated have been explained. Next, examples in which jump training is evaluated will be explained in fourth to sixth embodiments below. Like the motion information processing apparatus 100 explained above with reference to FIG. 1, a motion information processing apparatus 100a described below has the motion information acquiring unit 10 connected thereto and is configured to perform various types of processing by using the motion information generated by the motion information acquiring unit 10.

### Fourth Embodiment

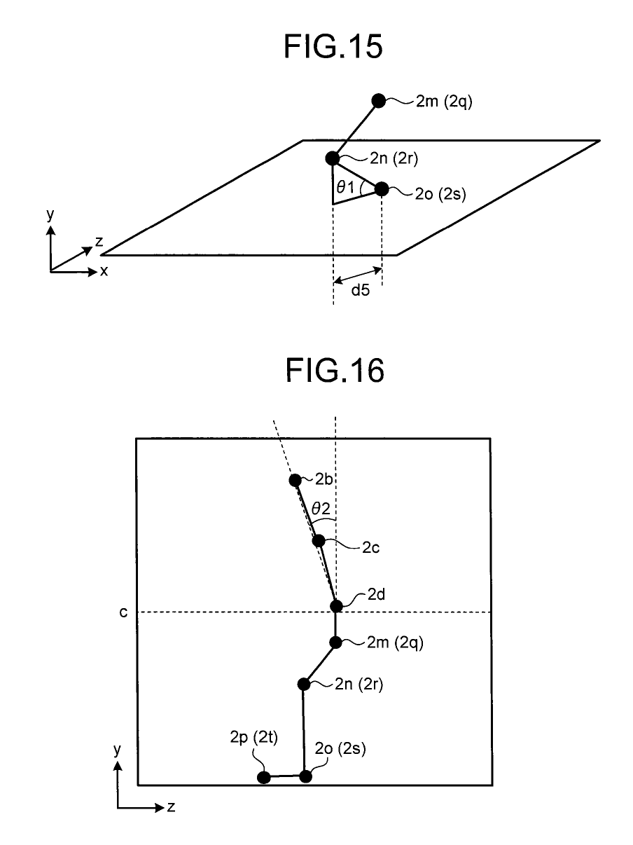

The motion information processing apparatus 100a according to the fourth embodiment is configured as explained with reference to FIG. 1 and is able to easily and conveniently evaluate a quick motion by using a configuration explained in detail below. In exemplary embodiments below, an example in which jump training is performed as the quick motion will be explained. FIG. 17 is a diagram of an exemplary detailed configuration of the motion information processing apparatus 100a according to the fourth embodiment. First, details of a storage unit 130a included in the motion information processing apparatus 100a will be explained. As illustrated in FIG. 17, in the motion information processing apparatus 100a, for example, the storage unit 130a includes a motion information storage unit 131a and a setting information storage unit 132a.

The motion information storage unit 131a is configured to store therein the various types of information acquired by the motion information acquiring unit 10. More specifically, the motion information storage unit 131a stores therein the motion information generated by the motion information generating unit 14. Even more specifically, the motion information storage unit 131a stores therein the skeleton information corresponding to each of the frames generated by the motion information generating unit 14. In this situation, the motion information storage unit 131a may further store therein the color image information, the distance image information, and the speech recognition result that are output by the motion information generating unit 14, while keeping these pieces of information in correspondence with each of the frames.

Like the motion information storage unit 131 according to the first to the third embodiments, the motion information storage unit 131a stores therein, as illustrated in FIG. 5. For example, motion information in which, for each of the names, a name number, the date of training, and pieces of motion information are kept in correspondence with one another. In this situation, the “name number” is an identifier used for uniquely identifying the subject and is provided for each name. The “date of training” indicates the date on which the subject performed the jump training. The “motion information” represents the information acquired by the motion information acquiring unit 10.

For example, to continue the explanation with reference to FIG. 5, for example, the motion information storage unit 131a stores therein, as illustrated in FIG. 5, “Name: A; Name Number: 1; Date of Training: 20120801_{—}1; Motion Information: color image information, distance image information, speech recognition result, skeleton information, . . . ”. These pieces of information indicate that, as the motion information of the “first time” jump training performed by the person named “Name: A” of which the “Name Number” is “1” on “August 1st” in the year “2012”, motion information including “color image information”, “distance image information”, “speech recognition result”, and “skeleton information” is stored.

In this situation, in the motion information illustrated in FIG. 5, the “color image information”, the “distance image information”, the “speech recognition result”, and the “skeleton information” for each of all the frames that were taken during the jump training are stored in time-series order, while being kept in correspondence with the time.

Further, as illustrated in FIG. 5, the motion information storage unit 131a stores therein “Name: A; Name Number: 1; Date of Training: 20120801_{—}2; Motion Information: color image information, distance image information, speech recognition result, skeleton information, . . . ”. In other words, the motion information storage unit 131a stores therein, in the same manner, the motion information of the “second time” jump training performed by the person named “Name: A” on “August 1st” in the year “2012”.

Further, as illustrated in FIG. 5, the motion information storage unit 131a also stores therein motion information including “color image information”, “distance image information”, “speech recognition result”, and “skeleton information”, for the person identified as “Name: B; Name Number: 2”. As explained here, the motion information storage unit 131a stores therein the motion information of the jump training acquired for each of the subjects, while keeping the motion information in correspondence with each of the subjects. The motion information illustrated in FIG. 5 is merely an example. In other words, the motion information storage unit 131a may further store therein other information besides the “color image information”, the “distance image information”, the “speech recognition result”, and the “skeleton information”, illustrated in FIG. 5, while keeping the information in correspondence with one another. Further, for example, if the motion information acquiring unit 10 did not include the speech recognition unit 13, the motion information storage unit 131a would store therein information that includes no speech recognition result.

Further, the “color image information” and the “distance image information” included in the motion information contain image data in a binary format such as Bitmap, JPEG, or the like, or contain a link to such image data or the like. Further, instead of the recognition information described above, the “speech recognition result” included in the motion information may be audio data itself or a link to the recognition information or the audio data.

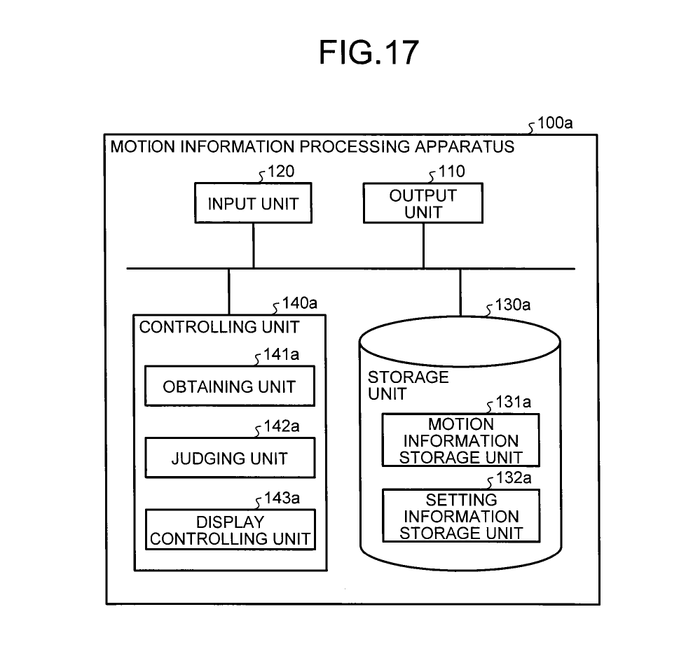

The setting information storage unit 132a is configured to store therein setting information used by a controlling unit 140a (explained later). More specifically, the setting information storage unit 132a stores therein the predetermined conditions used by the controlling unit 140a (explained later) for evaluating the quick motion performed by a rehabilitation subject. For example, the setting information storage unit 132a stores therein a condition used for judging whether the landing of a jump performed by a subject is performed with a correct posture. Next, a correct posture for the rehabilitation jump training will be explained, with reference to FIG. 18.

FIG. 18 is a drawing for explaining postures of a subject during rehabilitation jump training according to the fourth embodiment. In FIG. 18, FIG. 18(A) illustrates a jump with a correct posture, whereas FIG. 18 (B) illustrates a jump with an incorrect posture. For example, to have a correct posture in the jump training, as illustrated in FIG. 18(A), it is important that the subject's legs are neither in a “knock-kneed” state nor a “bow-legged” state, when the subject is standing and is about to jump, as well as throughout the jump, and when the subject has landed.

In other words, as illustrated in FIG. 18(B), if the subject lands in a “knock-kneed” state where the legs are curved inwardly, the subject has an incorrect posture. Also, although not illustrated in the drawings, if the subject lands in a “bow-legged” state where the legs are curved outwardly, the subject has an incorrect posture.

Accordingly, the setting information storage unit 132a is configured to store therein various types of setting information used for evaluating a correct jump landing posture such as that illustrated in FIG. 18, for example. In one example, the setting information storage unit 132a stores therein setting information used for judging the degree of “knock-kneed” state and the degree of “bow-legged” state at the time of the landing of a jump. Details of the setting information above will be explained more specifically later.

Next, details of the controlling unit 140a included in the motion information processing apparatus 100a will be explained. As illustrated in FIG. 17, in the motion information processing apparatus 100a, for example, the controlling unit 140a includes an obtaining unit 141a, a judging unit 142a, and a display controlling unit 143a.

The obtaining unit 141a is configured to obtain motion information of a subject who performs a quick motion. More specifically, the obtaining unit 141a obtains the motion information acquired by the motion information acquiring unit 10 and stored in the motion information storage unit 131a. For example, the obtaining unit 141a obtains the color image information, the distance image information, the speech recognition result, the skeleton information, and the like that are stored in the motion information storage unit 131a for each of the frames. In one example, the obtaining unit 141a obtains all the pieces of color image information, distance image information, and skeleton information that are related to a series of motions during the jump training of the subject.

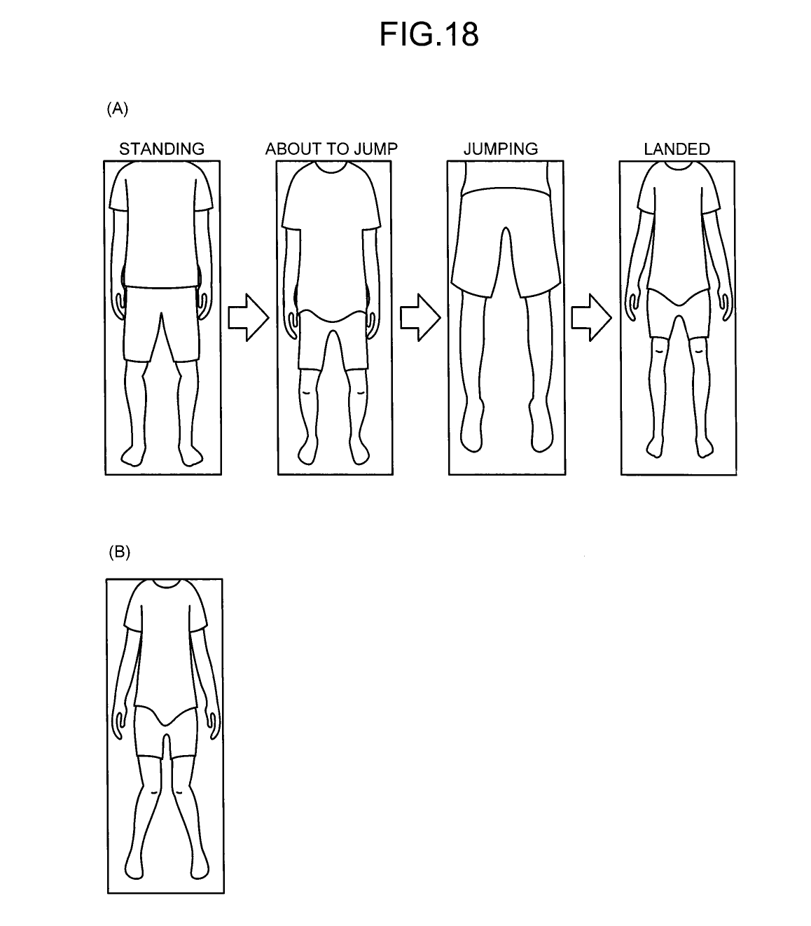

FIG. 19 is a drawing of an example of the skeleton information obtained by the obtaining unit 141a according to the fourth embodiment. FIG. 19 illustrates the example of the skeleton information of a subject who performs jump training. FIG. 19 illustrates an example in which the subject is positioned facing straight to the motion information acquiring unit 10. However, possible embodiments are not limited to this example. For instance, it is acceptable if the subject is positioned sideways to, at the back of, at an angle to, above, or beneath the motion information acquiring unit 10. In other words, the motion information acquiring unit 10 may be arranged in any position with respect to the subject. As illustrated in FIG. 19, for example, the obtaining unit 141a obtains the skeleton information of the subject who performs the jump training while being positioned facing straight to the motion information acquiring unit 10. In other words, the obtaining unit 141a acquires the skeleton information of all the frames acquired by the motion information acquiring unit 10.

On the basis of the predetermined conditions for the quick motion, the judging unit 142a is configured to judge whether the motion of the subject indicated by the motion information obtained by the obtaining unit 141a satisfies a certain condition included in the predetermined conditions. More specifically, the judging unit 142a judges whether the skeleton information of the subject for each of the frames obtained by the obtaining unit 141a satisfies conditions of the setting information stored in the setting information storage unit 132a. For example, on the basis of the predetermined conditions used when jump training is performed, the judging unit 142a judges whether the jump performed by the subject indicated by the skeleton information obtained by the obtaining unit 141a satisfies a certain condition included in the predetermined conditions stored in the setting information storage unit 132a.

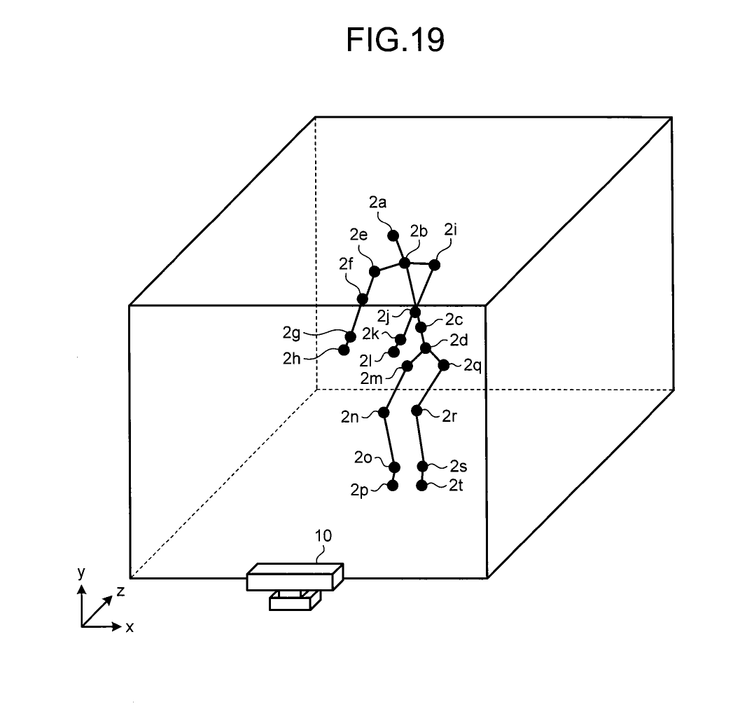

In one example, as the predetermined conditions used when jump training is performed, the judging unit 142a uses at least one of the degree of knock-kneed state and the degree of bow-legged state at the time of the landing of the jump. For example, as the predetermined condition used when a jump is performed, the judging unit 142a uses an opening amount of the legs at the time of the landing of the jump. FIG. 20 is a drawing for explaining an example of a jump training judging process performed by the judging unit 142a according to the fourth embodiment. FIG. 20 illustrates an example in which the judging unit 142a judges the degree of knock-kneed state at the time of the landing of a jump. Also, FIG. 20 illustrates the example in which the subject is performing the jump training while being positioned facing straight to the motion information acquiring unit 10.

For example, as illustrated in FIG. 20, the judging unit 142a judges the degree of knock-kneed state at the time of the landing by using coordinate information of the buttocks, the knees, and the ankles before the landing of the jump and after the landing of the jump. In other words, as illustrated in FIG. 20, the judging unit 142a judges the degree of knock-kneed state at the time of the landing, by judging whether a horizontal distance “d6” between the line connecting the joint “2m” corresponding to the right buttock to the joint “2o” corresponding to the right ankle and the joint “2n” corresponding to the right knee exceeds a predetermined threshold value. Alternatively, the judging unit 142a judges the degree of knock-kneed state at the time of the landing by judging whether a horizontal distance between the line connecting the joint “2q” corresponding to the left buttock to the joint “2s” corresponding to the left ankle and the joint “2r” corresponding to the left knee exceeds the predetermined threshold value.

In this situation, the threshold value used for judging the distance “d6” may arbitrarily be set by the user (e.g., the subject, a caregiver, or the like). In one example, the threshold value for “d6” may arbitrarily be set according to the age and the gender of the subject, whether the rehabilitation is performed after injury treatment or the rehabilitation is performed from the standpoint of preventive medicine or sports medicine. In this situation, the threshold value for “d6” may be set as an absolute position or a relative position. In other words, the threshold value may simply be set as a length from the position of the line between the buttock and the ankle to the position of the knee or may be set as a length to a position relative to a position of correct jump training. The various types of information used in the judging process described above are stored as the setting information in the setting information storage unit 132a. In other words, the judging unit 142a reads the setting information from the setting information storage unit 132a and performs the judging process.

Further, the judging unit 142a further judges whether the subject is performing the quick motion. If it has been determined that the subject is performing the quick motion, the judging unit 142a judges whether the motion of the subject indicated by the motion information obtained by the obtaining unit 141a satisfies the certain condition included in the predetermined conditions. For example, the judging unit 142a first judges whether the subject is performing jump training and, if it has been determined that the subject is performing jump training, the judging unit 142a judges whether the performed jump training is performed with a correct posture. In one example, the judging unit 142a judges whether the subject is performing jump training on the basis of changes in the value of the y-axis coordinates of predetermined joints of the subject. Next, an example of a judging process to judge whether jump training is performed will be explained.

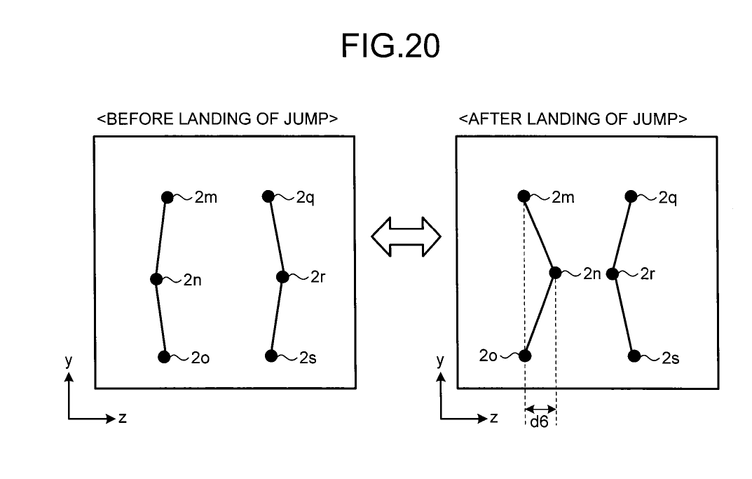

FIG. 21 is a drawing for explaining an example of a judging process performed by the judging unit 142a according to the fourth embodiment to judge whether jump training is performed. For example, as illustrated in FIG. 21, the judging unit 142a judges whether a jump is performed by calculating the difference between the height-direction y coordinate “y2” among the set of coordinates (x₂,y₂,z₂) of a predetermined joint (e.g., an ankle) of the subject in the current frame and the height-direction (vertical direction) y coordinate “y1” among the set of coordinates (x₁,y₁,z₁) in the immediately preceding frame.

In other words, when the subject jumps and goes up, as illustrated in FIG. 21(A), the value obtained by subtracting the y coordinate “y₁” in the immediately-preceding frame from the y coordinate “y₂” in the current frame is a positive value. In contrast, when the subject goes down, as illustrated in FIG. 21(B), the value obtained by subtracting “y₁” from “y₂” is a negative value. Further, when the subject reaches the ground, as illustrated in FIG. 21 (C), the value obtained by subtracting “y₁” from “y₂” is “0”.

In this situation, as illustrated in FIGS. 21(A) and 21(B), the judging unit 142a judges whether the subject performed a jump by using a threshold value A for the situation where the value obtained by subtracting “y₁” from “y₂” is a positive value and a threshold value B for the situation where the value obtained by subtracting “y₁” from “y₂” is a negative value. For example, the judging unit 142a performs the judging process described above by using not only the coordinates of the left ankle, but also the height-direction y coordinates of the joint “2p” corresponding to the right ankle and determines that the subject performed a jump when the differences in the y coordinates of both of the ankles between the frames exceed the threshold value A and subsequently exceed the threshold value B.

After that, if it has been determined that the subject performed a jump, the judging unit 142a performs the jump training evaluation as illustrated in FIG. 20. The example illustrated in FIG. 21 is merely an example, and possible embodiments are not limited to this example. In other words, the judging process to judge whether the subject is performing jump training or not does not necessarily have to be realized in the manner illustrated in FIG. 21. For example, it is acceptable to judge whether the subject performed a jump by using changes in the height-direction coordinate of the joint “2a” corresponding to the head of the subject. Alternatively, it is also acceptable to judge whether the subject performed a jump by judging whether the height of the joint “2a” corresponding to the head of the subject exceeded a predetermined height set in advance. The information used in the judging process described above is stored as the setting information in the setting information storage unit 132a.

In addition, by using the motion information of the subject who performs the quick motion obtained by the obtaining unit 141a, the judging unit 142a is capable of calculating other various types of information besides the distance between the joints. More specifically, the judging unit 142a is capable of calculating an angle of joints, a speed, acceleration, and the like. After that, the judging unit 142a judges whether the quick motion (e.g., the jump training) is correct or not by using the calculated various types of information. Further, the judging unit 142a is capable of performing the judging process not only in a real-time manner while the subject is performing the jump training, but also by reading the motion information from the past, for example.

In that situation, for example, the subject himself/herself or an operator (e.g., a medical doctor or a physiotherapist) inputs an instruction request for a judging process via the input unit 120. In that situation, the operator causes the obtaining unit 141a to obtain desired piece of motion information by inputting the name of a subject, a name number, a date of training, and the like. The obtaining unit 141a obtains a corresponding piece of motion information of the subject for which the request was received via the input unit 120, from the motion information storage unit 131a. When the process is performed in a real-time manner while the jump training is being performed, it is also acceptable to configure the motion information to be automatically obtained without receiving an operation from the operator.

Returning to the description of FIG. 17, the display controlling unit 143a is configured to exercise control so that a judgment result obtained by the judging unit 142a is provided as a notification. More specifically, when the judging unit 142a has determined that the jump performed by the subject does not satisfy the certain condition included in the predetermined conditions, the display controlling unit 143a exercises control so that a warning is issued. Further, the display controlling unit 143a exercises control so that the output unit 110 displays various types of information related to an evaluation of the quick motion including the jump training.

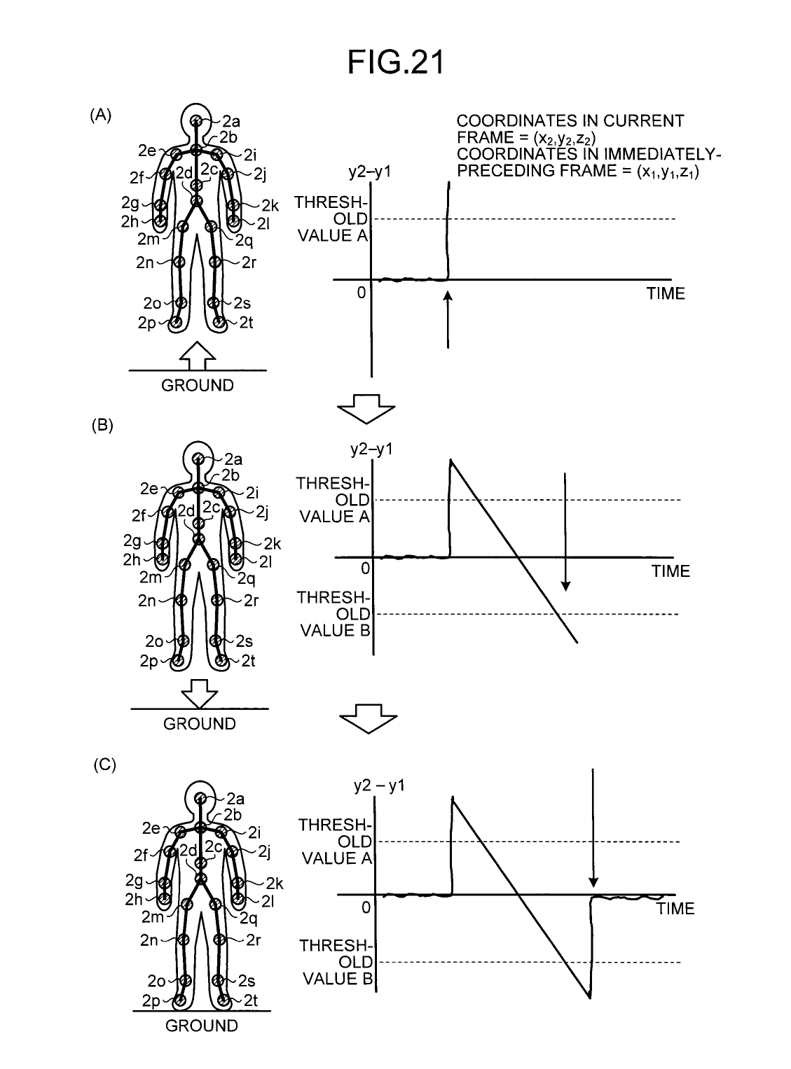

Next, examples of displayed contents displayed by the display controlling unit 143a will be explained, with reference to FIGS. 22 to 25. FIGS. 22 to 25 are drawings of examples of displayed contents on which display control is exercised by the display controlling unit 143a according to the fourth embodiment. For example, as illustrated in FIG. 22, the display controlling unit 143a causes the output unit 110 to display, as a jump training evaluation aiding function window, a GUI including a display region R3 for displaying the color image information of the subject and a display region R4 for displaying various types of information related to a jump evaluating process.

In this situation, as illustrated in the display region R3 in FIG. 22, the display controlling unit 143a causes a superimposed image to be displayed in which positions of joints and lines connecting the joints are superimposed on a color image of the subject. As a result, a viewer who views the output unit 110 is able to clearly observe movements of different sites of the subject. Further, as illustrated in the display region R4 in FIG. 22, the display controlling unit 143a displays a switch button used for switching on and off the function of evaluating the jump training of the subject, a checkbox used for turning the jump judging function on, a box for inputting a threshold value, a setting button for setting the threshold value, and measured results.

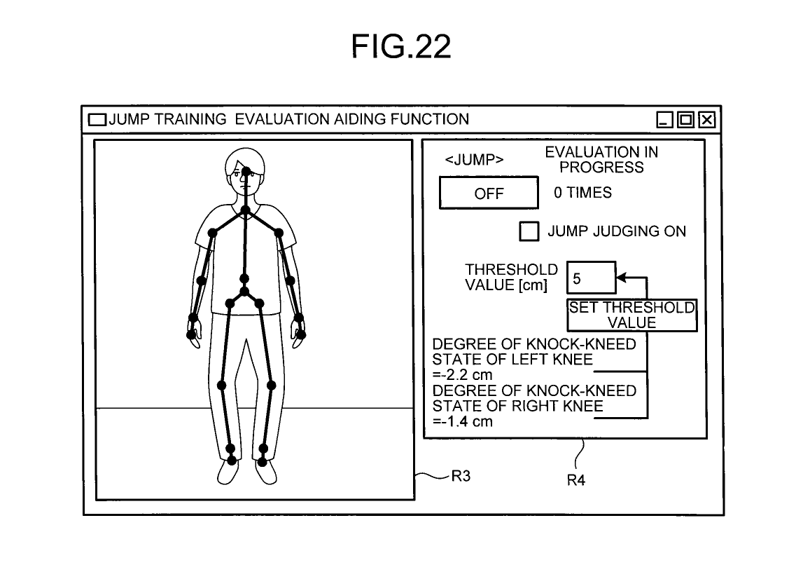

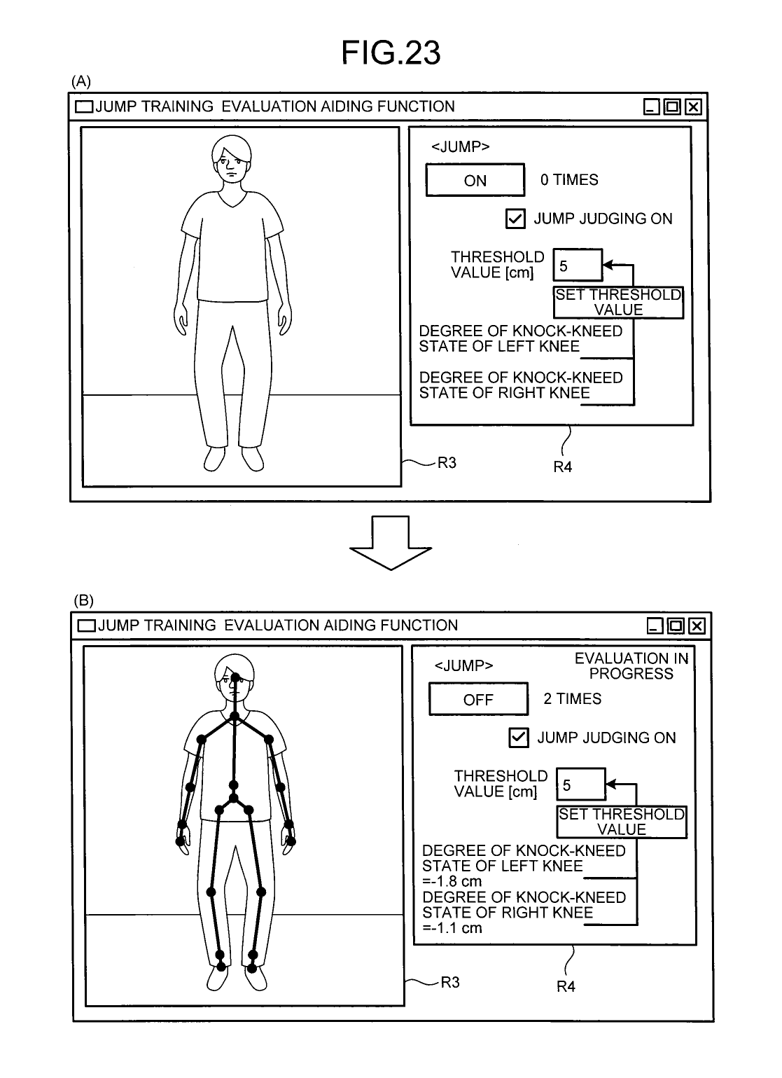

Next, an example of a series of processes during a jump training evaluation will be explained, with reference to FIGS. 23 and 24. For example, when a subject is to perform jump training, when an application having a jump training evaluation aiding function is activated via the input unit 120 of the motion information processing apparatus 100a, the display controlling unit 143a causes the output unit 110 to display the jump training evaluation aiding function window illustrated in FIG. 23(A). In this situation, in conjunction with the activation of the application, the motion information processing apparatus 100a sets the camera up-and-down angle of the motion information acquiring unit 10 to “0 degrees”. As a result, it is possible to utilize the coordinates in the depth direction (the degree of depth), without having to make a correction. When the camera up-and-down angle of the motion information acquiring unit 10 is not set to “0 degrees”, the coordinates in the depth direction are corrected on the basis of the current angle of the camera.

Further, as illustrated in FIG. 23(A), the subject stands so as to be positioned facing straight to the camera of the motion information acquiring unit 10 and performs jump training. In this situation, the motion information processing apparatus 100a may be configured to start the jump training evaluation at the same time as the application is activated or may be configured to receive an instruction to start the evaluation. For example, the subject may start the evaluation process by pressing, with the use of a mouse or the like, the switch button illustrated in FIG. 23(A) used for switching on and off the jump training evaluation function.

In other words, when the subject presses the “ON” button illustrated in FIG. 23(A), the motion information processing apparatus 100a displays the text “evaluation in progress” as illustrated in FIG. 23(B) and starts the jump training evaluation. In this situation, if the checkbox used for turning on the jump judging function displayed in the display region R4 is checked as illustrated in FIG. 23(B), the motion information processing apparatus 100a first judges whether the subject performed a jump motion, and if it has been determined that the subject performed a jump motion, the motion information processing apparatus 100a starts the jump training evaluation.

In other words, on the basis of the motion information acquired by the motion information acquiring unit 10, the judging unit 142a judges whether the subject is performing jump training, by performing the judging process illustrated in FIG. 21, for example. After that, if it has been determined that the subject is performing jump training, the judging unit 142a further performs the jump training evaluation by performing the judging process illustrated in FIG. 20, for example.

In this situation, the predetermined threshold value related to the conditions of the setting information used for evaluating the jump training is arbitrarily set. For example, as illustrated in FIG. 23(B), the judging unit 142a performs a threshold value (cm) judging process on the degree of knock-kneed state of the left knee and the degree of knock-kneed state of the right knee. In this situation, as illustrated in FIG. 23(B), when a numerical value “5” is directly input in the threshold value (cm) box, the judging unit 142a judges whether the degree of knock-kneed state of the left knee or the degree of knock-kneed state of the right knee exceeds “5 cm” or not.

In other words, the judging unit 142a calculates the degree of knock-kneed state of the left knee or the degree of knock-kneed state of the right knee for each of all the frames acquired by the motion information acquiring unit 10 and judges whether each of the distances exceeds “5 cm” or not. For example, as illustrated in FIG. 23(B), if the degree of knock-kneed state of the left knee is “−1.8 cm”, whereas the degree of knock-kneed state of the right knee is “−1.1 cm”, the judging unit 142a determines that the condition for the jump training is satisfied.

In contrast, as illustrated in FIG. 24, if the degree of knock-kneed state of the left knee is “4.8 cm”, and the degree of knock-kneed state of the right knee is “5.8 cm”, the judging unit 142a determines that the condition for the jump training is not satisfied. In that situation, as illustrated in FIG. 24, for example, the display controlling unit 143a implements a warning display to cause a predetermined color to be displayed on the color image in a superimposed manner. After that, the display controlling unit 143a displays “1 time” as the number of times the condition was not satisfied, as illustrated in FIG. 24.

The example in FIG. 24 illustrates the situation where the judging process is performed by judging whether the degrees of knock-kneed state of both of the knees satisfy the condition or not. However, possible embodiments are not limited to this example. For instance, it is acceptable to judge whether the degree of knock-kneed state satisfies the condition for each knee. In that situation, for example, the display controlling unit 143a displays display information so as to provide a notification indicating which knee had a degree of knock-kneed state that was determined by the judging unit 142a as not satisfying the condition. In one example, if the judging unit 142a has determined that the degree of knock-kneed state of the right knee does not satisfy the condition, the display controlling unit 143a implements the warning display only on the right side of the screen.

As explained above, the judging unit 142a may perform the judging process on the basis of the absolute positions of the sites of the subject, by using the directly-input value as the threshold value. However, the judging unit 142a may also perform a judging process on the basis of relative positions. For example, the judging unit 142a may perform a judging process by setting a state of the subject satisfying a predetermined condition as a reference state and comparing the difference from the reference state with a threshold value. In one example, when the subject performed a jump that satisfies the condition or when it is presumed that the subject performed a jump that satisfies the condition, the threshold value setting button included in the display region R4 is pressed. In other words, for example, the subject sets a value corresponding to the state where the degrees of knock-kneed state and bow-legged state are low as the threshold value. Alternatively, it is also acceptable to automatically set information about a relative position used by the controlling unit 140a as a reference position. In one example, the controlling unit 140a sets the degrees of knock-kneed state and bow-legged state obtained when the subject was determined by the judging unit 143a to have performed a jump that satisfies the condition, as a reference degree. Alternatively, when the judging unit 143a presumes that the subject performed a jump that satisfies the condition (when the subject is in a state where the jump training condition is satisfied while the jump judging function is off), the controlling unit 140a sets the degrees of knock-kneed state and bow-legged state corresponding to the state satisfying the condition, as a reference degree. With any of these arrangements, the motion information processing apparatus 100a evaluates the jump training by using the state as a reference state and judging how much the jumps performed thereafter deviate from the reference state. The tolerance amount for deviations from the reference state may arbitrarily be set.

Further, FIG. 24 illustrates the example in which the warning display is implemented on the color image. However, possible embodiments are not limited to this example. For instance, a warning sound may be output or a warning text may be displayed. In that situation, the controlling unit 140a exercises control so that the warning sound is output from the output unit 110 or the display controlling unit 143a exercises control so that the warning text is displayed.

The display examples illustrated in FIGS. 22 to 24 are merely examples. The display controlling unit 143a is capable of causing other various types of information to be displayed as the display information. For example, the display controlling unit 143a may exercise control so that the total count of jump motions is displayed. In one example, the display controlling unit 143a is capable of causing information to be displayed such as “the number of times the condition was not satisfied/the total jump count” together with the text “1 time” displayed as the number of times the condition was not satisfied illustrated in FIG. 24. In that situation, when the judging unit 142a has determined that the subject is performing a jump motion, the display controlling unit 143a increments the total jump count.

Further, FIGS. 22 to 24 illustrate the example in which, when the jump motion performed by the subject does not satisfy the condition, the warning is issued so that the number of times a waning is issued is counted. However, possible embodiments are not limited to this example. For instance, another arrangement is acceptable in which, when the jump motion performed by the subject satisfies the condition, information indicating that the motion is normal is provided as a notification so that the number of times a normal motion is performed is counted. In that situation, for example, when the judging unit 142a has determined that a jump performed by the subject satisfies the certain condition included in the predetermined conditions, the display controlling unit 143a notifies that the motion is normal (e.g., displays a circle on the screen) and increments the count for the number of times a normal motion is performed that is displayed on the screen.

The examples of the displayed contents displayed under the control of the display controlling unit 143a have thus been explained. The examples described above are merely examples. The display controlling unit 143a is capable of causing various types of displayed contents to be displayed. For instance, in the description above, the example in which the subject is a single person is explained; however, there may be two or more subjects.

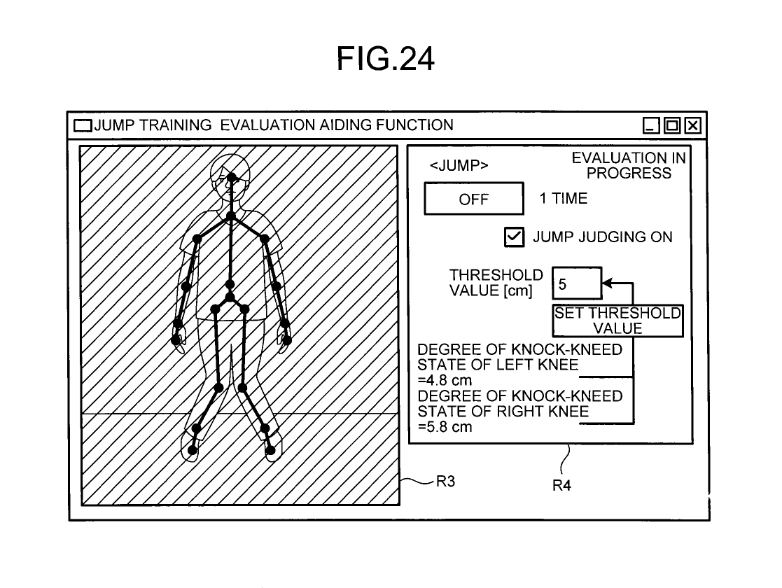

For example, as illustrated in FIG. 25, the display controlling unit 143a causes color images of a jump subject 1 and a jump subject 2 to be displayed in the window of the jump training evaluation aiding function. After that, as illustrated in FIG. 25, the display controlling unit 143a causes text to be displayed between the color images so as to read “evaluation”, “total count”, “number of times of warning”, “degree of knock-kneed state of left knee”, and “degree of knock-kneed state of right knee” and causes an evaluation start button to be displayed underneath. The display example illustrated in FIG. 25 is merely an example, and possible embodiments are not limited to this example. In other words, the display controlling unit 143a is capable of further causing other information to be displayed that is different from the information illustrated in the drawing. The display controlling unit 143a is also capable of exercising control so that the information illustrated in the drawing is not displayed. In one example, the display controlling unit 143a is capable of exercising control so that the “degree of knock-kneed state of the left knee” and the “degree of knock-kneed state of the right knee” are not displayed.

In this situation, the evaluation start button illustrated in FIG. 25 is an ON/OFF button that is used in common for both of the subjects as illustrated in FIG. 25. When the “ON” button is pressed, a measuring process for both of the subjects is started. When the “OFF” button is pressed, the measuring process for both of the subjects is ended. For example, while the jump subject 1 and the jump subject 2 are standing so as to be positioned facing straight to the motion information acquiring unit 10, when the ON/OFF button is pressed, the motion information acquiring unit 10 acquires motion information of both of the subjects. The display controlling unit 143a is also capable of exercising control so that, when the OFF button is pressed, the count values for the “total count” and “number of times of warning” are initialized (reset) to “0”.

The obtaining unit 141a obtains the motion information for each of all the frames of both of the subjects and sends the obtained motion information to the judging unit 142a. On the basis of the motion information obtained by the obtaining unit 141a, the judging unit 142a judges the jump training of the jump subject 1 and the jump subject 2. The display controlling unit 143a displays judgment results of the jump training of the jump subject 1 and the jump subject 2 obtained by the judging unit 142a. In this situation, as illustrated in FIG. 25, the display controlling unit 143a may display “Good!!” or “Bad . . . ” as evaluation results. The evaluation results may be obtained by comparing the numbers of times a warning was issued between the two subjects so that the subject having the smaller count is displayed with “Good!!”, while the other subject having the larger count is displayed with “Bad . . . ”. Alternatively, “Good!!” may be displayed when the number of times a warning was issued is less than 3, and “Bad . . . ” may be displayed when the number of times a warning was issued is 5 or more.

In the exemplary embodiment described above, the example is explained in which the jump training is evaluated in a real-time manner, while the jump training is being performed. However, possible embodiments are not limited to this example. For instance, jump training may be evaluated by using the motion information of jump training that was performed in the past.

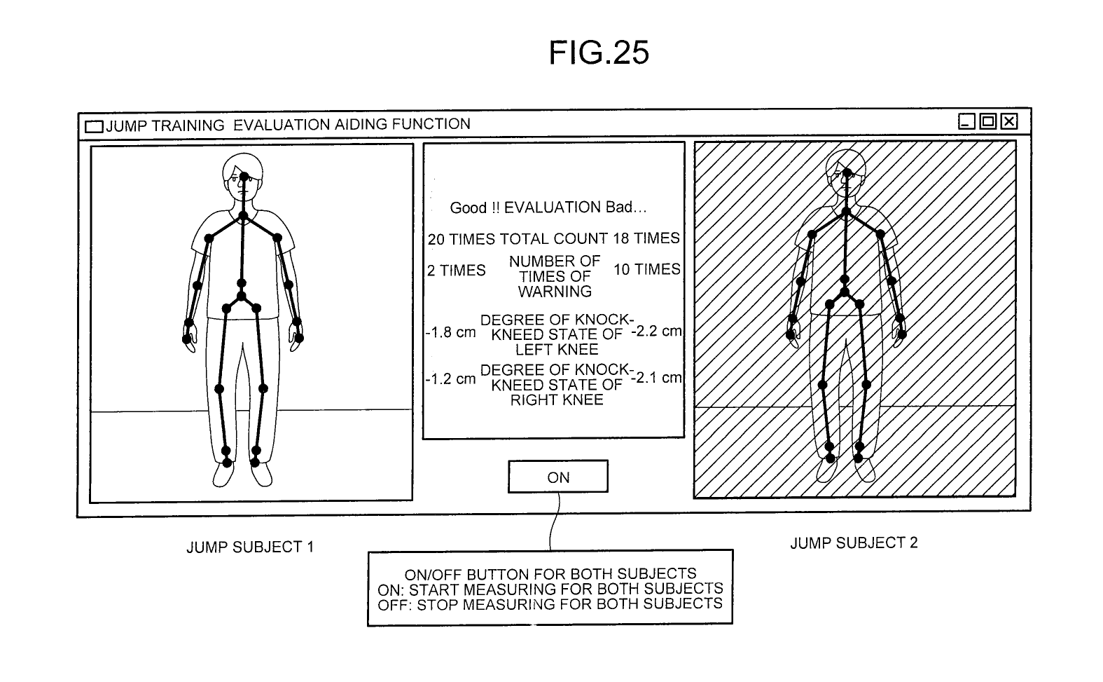

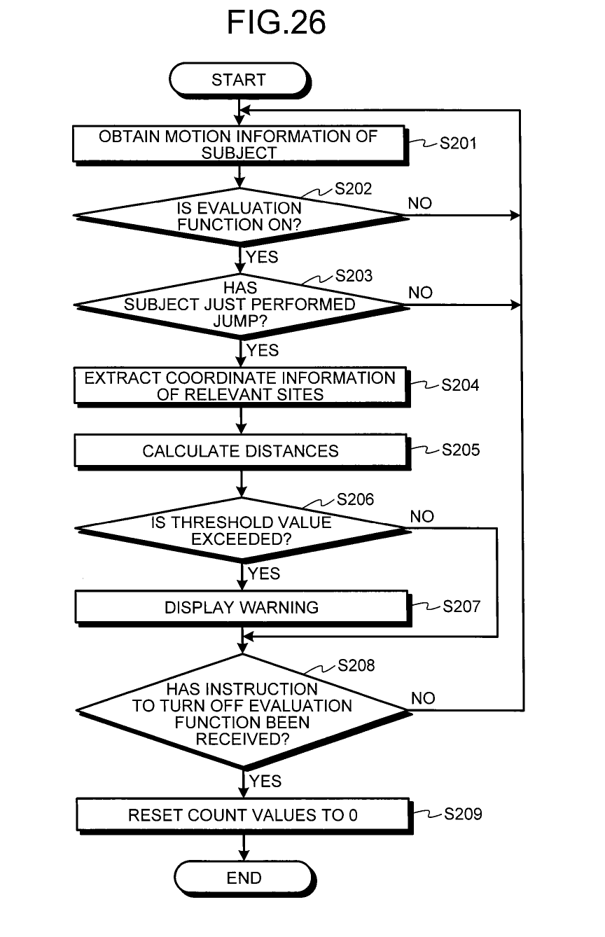

Next, a process performed by the motion information processing apparatus 100a according to the fourth embodiment will be explained, with reference to FIGS. 26 and 27. FIGS. 26 and 27 are flowcharts of a procedure in the process performed by the motion information processing apparatus 100a according to the fourth embodiment. FIG. 26 illustrates an example in which the evaluation is performed in a real-time manner. Further, FIG. 26 illustrates an example in which the evaluation function can be switched on and off by using the evaluation start button. FIG. 27 is a flowchart of details of the process performed at step S203 in FIG. 26. FIGS. 26 and 27 will be explained below in the stated order.

As illustrated in FIG. 26, in the motion information processing apparatus 100a according to the fourth embodiment, when a subject who is to perform jump training appears in front of the motion information acquiring unit 10, the obtaining unit 141a obtains motion information of the subject (step S201). After that, when the evaluation start button to start a jump evaluation is pressed, the judging unit 142a judges whether the evaluation function is on (step S202).

If the evaluation function is on (step S202: Yes), the judging unit 142a judges whether the subject has just performed a jump (step S203). If the subject has just performed a jump (step S203: Yes), the judging unit 142a extracts coordinate information of relevant sites (e.g., the buttocks, the knees, and the ankles) (step S204), calculates the distances (step S205), and judges whether the threshold value is exceeded (step S206).

If at least one of the distances exceeds the threshold value (step S206: Yes), the display controlling unit 143a displays a warning (step S207), and judges whether an instruction to turn off the evaluation function is received (step S208). On the contrary, if the threshold value is not exceeded (step S206: No), the display controlling unit 143a judges whether an instruction to turn off the evaluation function is received (step S208).

If an instruction to turn off the evaluation function is received (step S208: Yes), the motion information processing apparatus 100a resets the count values of the number of times of warning and the total count to indicate “0” times (step S209), and the process is ended. On the contrary, if no instruction to turn off the evaluation function is received (step S208: No), the process returns to step S201 so that the motion information processing apparatus 100a continues to obtain motion information of the subject. Also, when the evaluation function is off (step S202: No) or when the subject is not performing a jump (step S203: No), the process returns to step S201, so that the motion information processing apparatus 100a continues to obtain motion information of the subject.

The procedure in the process is described above using the example in which it is judged whether the subject is performing a jump (when the jump judging function is on). However, the motion information processing apparatus 100a according to the fourth embodiment may also perform an evaluation even if the jump judging function is off. In that situation, during the procedure in the process illustrated in FIG. 26, if the evaluation function is on at step S202, the process at step S204 is performed to extract the coordinate information of the relevant sites, without performing the process at step S203 to judge whether the subject is performing a jump.

Next, details of the process at step S203 will be explained. As illustrated in FIG. 27, if the evaluation function is on at step S202, the judging unit 142a obtains the coordinates information of the predetermined joint (e.g., an ankle) (step S301). After that, the judging unit 142a calculates the difference between the height-direction coordinate in the current frame and the height-direction coordinate in the immediately-preceding frame, with respect to the predetermined joint (step S302), and judges whether the difference is equal to or larger than the positive threshold value A (step S303).

If the difference is equal to or larger than the threshold value A (step S303: Yes), the judging unit 142a obtains the coordinate information of the predetermined joint (step S304). Subsequently, the judging unit 142a calculates the difference between the height-direction coordinate in the current frame and the height-direction coordinate in the immediately-preceding frame, with respect to the predetermined joint (step S305), and judges whether the difference is equal to or smaller than the negative threshold value B (step S306).

If the difference is equal to or smaller than the threshold value B (step S306: Yes), the judging unit 142a determines that the subject has just performed a jump (step S307) and performs the process at step S204. On the contrary, if the difference at step S303 is not equal to or larger than the threshold value A (step S303: No), the judging unit 142a returns to step S301. If the difference at step S306 is not equal to or smaller than the threshold value B (step S306: No), the judging unit 142a returns to step S304.

During the process at steps S304 through S306, there is a possibility that the process enters a loop of these steps if the condition is not satisfied in the judging process at step S306. To cope with this situation, it is also acceptable to exercise control in such a manner that the process returns to step S301 if a predetermined period of time has elapsed. For example, it is acceptable to exercise control in such a manner that the process returns to step S301 if the condition at step S306 is not satisfied within two seconds after passing through step S304.

As explained above, according to the fourth embodiment, the obtaining unit 141a obtains the motion information of the subject who performs the jump motion. On the basis of the predetermined conditions for the jump motion, the judging unit 142a judges whether the motion of the subject indicated by the motion information obtained by the obtaining unit 141a satisfies the certain condition included in the predetermined conditions. The controlling unit 140a exercises control so that the judgment result obtained by the judging unit 142a is provided as a notification. Accordingly, the motion information processing apparatus 100a according to the fourth embodiment is able to evaluate the jump motion, by only having the subject perform the jump motion in front of the motion information acquiring unit 10. The motion information processing apparatus 100a thus makes it possible to easily and conveniently evaluate the jump motion.

As a result, for example, even when the subject undergoes rehabilitation by himself/herself, the motion information processing apparatus 100a is able to prompt the subject to undergo the rehabilitation with a correct posture. Thus, the motion information processing apparatus 100a is able to compensate for a shortage of caregivers and makes it possible for the subject to undergo rehabilitation that is better than a certain level, without being conditioned by the level of skills of the caregiver.

Further, according to the fourth embodiment, the controlling unit 140a exercises control so as to notify that the motion is normal when the judging unit 142a has determined that the jump performed by the subject satisfies the certain condition included in the predetermined conditions and so that the warning is issued when the judging unit 142a has determined that the jump performed by the subject does not satisfy the certain condition included in the predetermined conditions. Consequently, the motion information processing apparatus 100a according to the fourth embodiment makes it possible to easily and conveniently evaluate the jump training, which is considered important from the standpoint of preventive medicine and sports medicine.

Further, according to the fourth embodiment, the judging unit 142a uses at least one of the degree of knock-kneed state and the degree of bow-legged state at the time of the landing of the jump, as the predetermined condition used when a jump is performed. Consequently, the motion information processing apparatus 100a according to the fourth embodiment is able to perform the evaluation on the basis of the important motion at the time of the landing of the jump and thus makes it possible to prompt the subject to perform a jump with a more correct posture.

Further, according to the fourth embodiment, the judging unit 142a uses the opening amount of the legs at the time of the landing of the jump, as the predetermined condition used when a jump is performed. Consequently, the motion information processing apparatus 100a according to the fourth embodiment is able to easily and conveniently judge the degree of knock-kneed state and the degree of bow-legged state at the time of the landing of the jump of the subject and thus makes it possible to easily and conveniently evaluate the jump training.

Further, according to the fourth embodiment, the judging unit 142a further judges whether the subject is performing a jump motion, and if it has been determined that the subject is performing a jump motion, the judging unit 142a judges whether the motion of the subject indicated by the motion information obtained by the obtaining unit 141a satisfies the certain condition included in the predetermined conditions. Consequently, the motion information processing apparatus 100a according to the fourth embodiment prevents the judging process from being performed on motions that are irrelevant to the motion being the target of the evaluation. The motion information processing apparatus 100a thus makes it possible to provide clearer judgment results.

Further, according to the fourth embodiment, with respect to the predetermined conditions used by the judging unit 142a, the input unit 120 receives the input operation for setting the predetermined threshold value used for judging whether the certain condition is satisfied or not. Consequently, the motion information processing apparatus 100a according to the fourth embodiment is able to set a fine-tuned threshold value for each subject and thus makes it possible to easily and conveniently perform the evaluation properly.

Further, according to the fourth embodiment, the input unit 120 receives at least one of the threshold value for the absolute position and the threshold value for the relative position with respect to the predetermined conditions. Consequently, the motion information processing apparatus 100a according to the fourth embodiment makes it possible to easily and conveniently perform the evaluation in a flexible manner.

Further, according to the fourth embodiment, the input unit 120 further receives the input operation for starting the judging process performed by the judging unit 142a. Consequently, the motion information processing apparatus 100a according to the fourth embodiment is able to prevent the evaluation from being automatically performed on motions irrelevant to the evaluation and is able to perform the evaluation only on the motion being the target of the evaluation. Thus, the motion information processing apparatus 100a makes it possible to provide clearer evaluation results.

### Fifth Embodiment

In the fourth embodiment described above, the example in which the jump training is evaluated on the basis of the degree of knock-kneed state at the time of the landing of the jump was explained. However, possible embodiments are not limited to this example. For instance, it is acceptable to evaluate jump training on the basis of the degree of bow-legged state at the time of the landing of a jump. As a fifth embodiment, an example in which jump training is evaluated on the basis of a degree of bow-legged state at the time of the landing will be explained. The judging processes explained below may additionally be used together with the jump training judging process that uses the degree of knock-kneed state at the time of the landing explained in the fourth embodiment or may be used alone. The fifth embodiment is different from the fourth embodiment for the contents of the process performed by the judging unit 142a. The fifth embodiment will be explained below while a focus is placed on the difference.

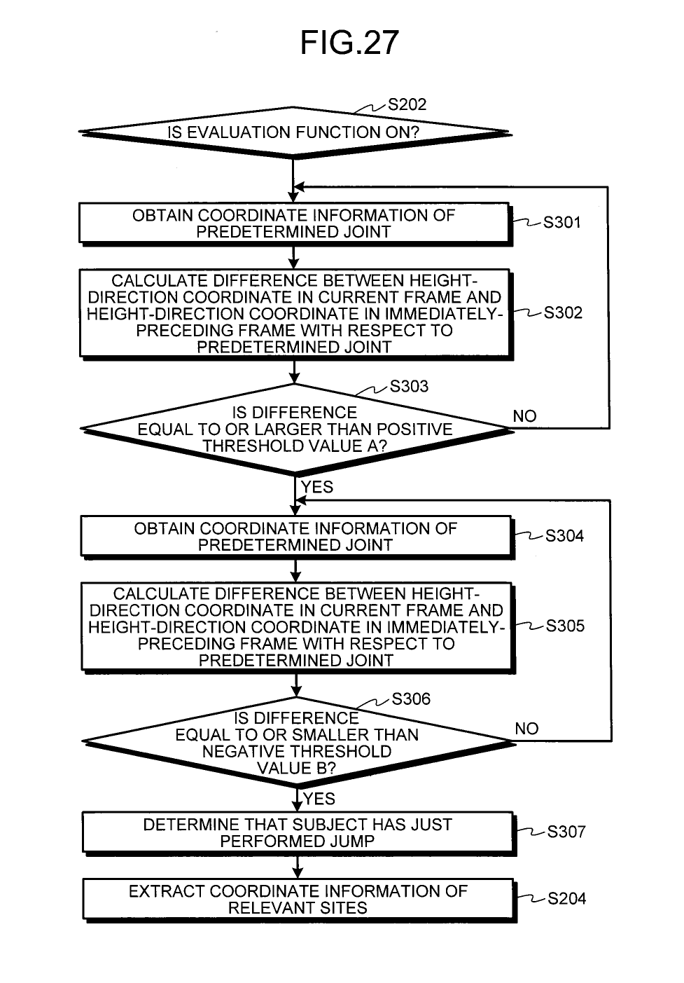

The judging unit 142a according to the fifth embodiment performs a judging process by using a degree of bow-legged state at the time of the landing of a jump. FIG. 28 is a drawing for explaining an example of a jump training judging process performed by the judging unit 142a according to the fifth embodiment. For example, as illustrated in FIG. 28, the judging unit 142a judges the degree of bow-legged state at the time of the landing by using the coordinate information of the buttocks, the knees, and the ankles before the landing of the jump and after the landing of the jump. In other words, as illustrated in FIG. 28, the judging unit 142a judges the degree of bow-legged state at the time of the landing by judging whether a horizontal distance “d7” between the line connecting the joint “2m” corresponding to the right buttock to the joint “2o” corresponding to the right ankle and the joint “2n” corresponding to the right knee exceeds a predetermined threshold value. Alternatively, the judging unit 142a judges the degree of bow-legged state at the time of the landing by judging whether a horizontal distance between the line connecting the joint “2q” corresponding to the left buttock to the joint “2s” corresponding to the left ankle and the joint “2r” corresponding to the left knee exceeds the predetermined threshold value.

In this situation, the threshold value used for judging the distance “d7” may arbitrarily be set by the user (e.g., the subject, a caregiver, or the like). In one example, the threshold value for “d7” may arbitrarily be set according to the age and the gender of the subject, whether the rehabilitation is performed after injury treatment or the rehabilitation is performed from the standpoint of preventive medicine or sports medicine. In this situation, the threshold value for “d7” may be set as an absolute position or a relative position. In other words, the threshold value may simply be set as a length from the position of the line between the buttock and the ankle to the position of the knee or may be set as a length to a position relative to a position of correct jump training. The various types of information used in the judging process described above are stored as the setting information in the setting information storage unit 132a. In other words, the judging unit 142a reads the setting information from the setting information storage unit 132a and performs the judging process.

Further, the judging unit 142a further judges whether the subject is performing the quick motion. If it has been determined that the subject is performing the quick motion, the judging unit 142a judges whether the motion of the subject indicated by the motion information obtained by the obtaining unit 141a satisfies the certain condition included in the predetermined conditions. For example, the judging unit 142a first judges whether the subject is performing jump training and, if it has been determined that the subject is performing jump training, the judging unit 142a judges whether the performed jump training is performed with a correct posture.

The judging unit 142a according to the fifth embodiment evaluates the jump training by performing the various types of judging processes described above either each type alone or in combination as appropriate. Further, the display controlling unit 143a according to the fifth embodiment exercises control so as to notify that the motion is normal or so that the warning is issued, in accordance with the judgment result from the judging process.

As explained above, according to the fifth embodiment, the judging unit 142a performs the judging process by using the degree of bow-legged state at the time of the landing of the jump. Consequently, the motion information processing apparatus 100a according to the fifth embodiment is able to evaluate the jump training on the basis of whether the subject is in a bow-legged state, in addition to whether the subject is in a knock-kneed state, at the time of the landing of the subject who performs the jump training. The motion information processing apparatus 100a thus make it possible to easily and conveniently evaluate the jump training with a high level of precision.

### Sixth Embodiment

The fourth and the fifth embodiments have thus been explained. The present disclosure may be carried out in other various modes besides the fourth and the fifth embodiments described above.

In the fourth and the fifth embodiments described above, the examples are explained in which the subject who performs the jump training is positioned facing straight to the motion information acquiring unit 10. However, possible embodiments are not limited to these examples. For instance, the present disclosure is applicable to situations where the subject is not positioned facing straight to the motion information acquiring unit 10 (i.e., the subject is not oriented in the depth direction).

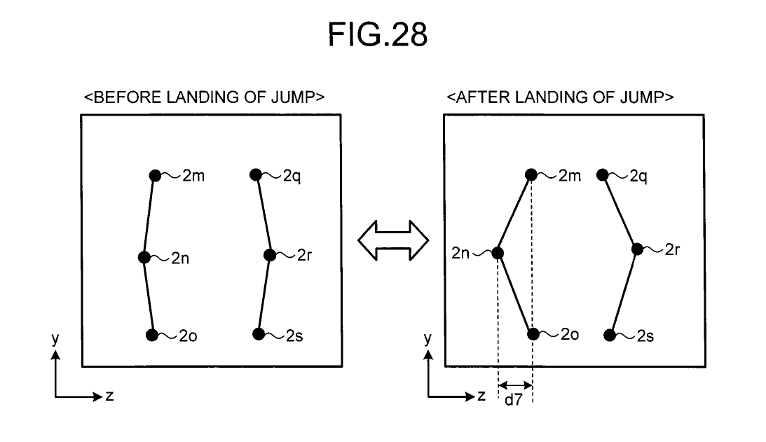

FIG. 29 is a drawing for explaining an example of a jump training judging process performed by the judging unit 142a according to a sixth embodiment. FIG. 29 illustrates the example of the jump training judging process performed by the judging unit 142a when the subject is not oriented in the depth direction. For example, as illustrated in FIG. 29, the judging unit 142a judges the degree of knock-kneed state and the degree of bow-legged state at the time of the landing by using position vectors. FIG. 29 illustrates a judging process performed by using vectors that connect together the joints corresponding to the buttocks, the knees, and the ankles.

For example, when the subject is standing vertically straight, the angle θ formed by a vector C_{R} expressed as an outer product of a vector A_{R} connecting “2m” to “2n” and a vector B_{R} connecting “2n” to “2o” and a vector C_{L} expressed as an outer product of a vector A_{L} connecting “2q” to “2r” and a vector B_{L} connecting “2r” to “2s” is “approximately 180 degrees” as illustrated in FIG. 29(A). In contrast, if the subject is standing in a knock-kneed state, the angle θ is smaller than “180 degrees” as illustrated in FIG. 29(B). On the contrary, if the subject is standing in a bow-legged state, the angle θ is larger than “180 degrees” as illustrated in FIG. 29(C).

Accordingly, the judging unit 142a calculates these vectors from the motion information acquired by the obtaining unit 141a and calculates the angle θ from the calculated vectors. After that, on the basis of the calculated angle θ, the judging unit 142a judges whether the jump training of the subject was performed with a correct posture.

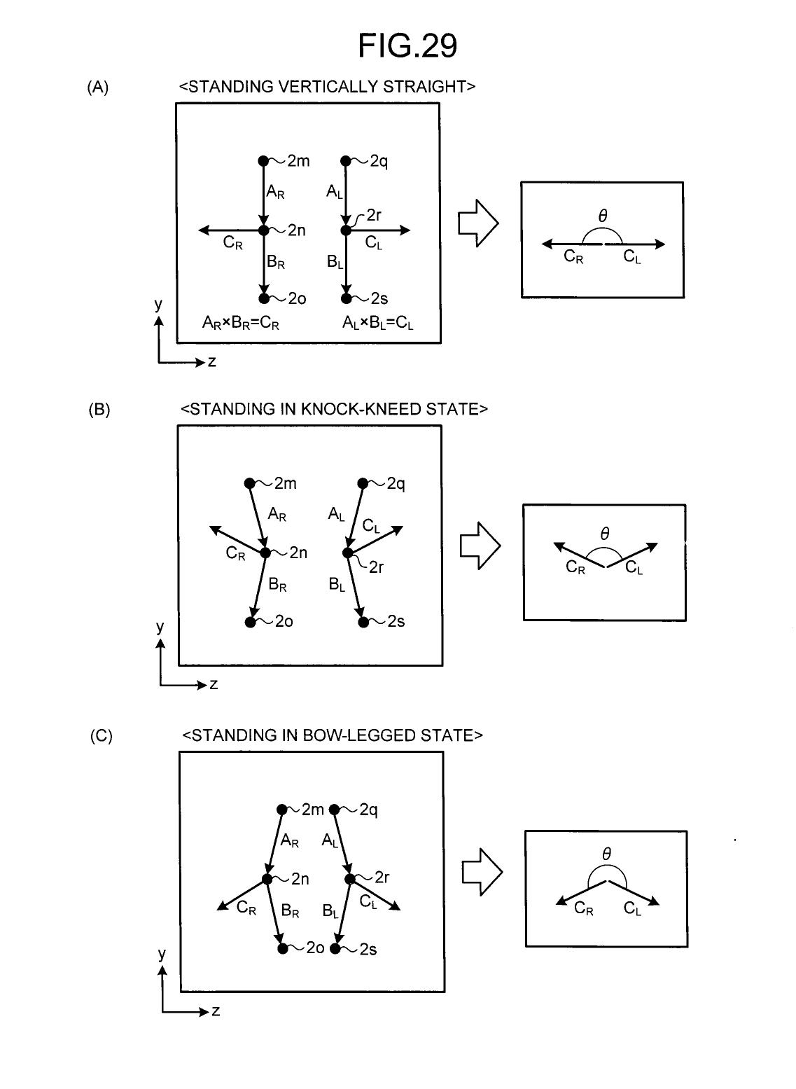

Further, it is also acceptable to judge the degree of knock-kneed state or the degree of bow-legged state by calculating how much the knees are positioned apart from each other on the basis of a distance (an inter-knee distance) between the right knee and the left knee. FIG. 30 is a drawing for explaining another example of the jump training judging process performed by the judging unit 142a according to the sixth embodiment. In the example illustrated in FIG. 30, because the subject is performing the jump training while not being positioned facing straight to the motion information acquiring unit 10, an inter-knee distance “d8” is calculated as “d8=√{(x14−x18)²+(y14−y18)²+(z14−z18)²}”. In other words, when the subject is not positioned facing straight to the motion information acquiring unit 10, the three-dimensional distance between the two points is calculated.

The judging unit 142a calculates the inter-knee distance “d8” in each of the frames and judges the degree of knock-kneed state and the degree of bow-legged state at the time of the landing of the jump, by comparing the values of “d8” with a predetermined threshold value. For example, if “d8” is smaller than the predetermined threshold value, the judging unit 142a determines that the subject is in a knock-kneed state. On the contrary, if “d8” is larger than the predetermined threshold value, the judging unit 142a determines that the subject is in a bow-legged state.

In this situation, the threshold value used for judging a knock-kneed state and a bow-legged state by using “d8” may arbitrarily be set by the user (e.g., the subject, a caregiver, or the like). In one example, the threshold value for “d8” may arbitrarily be set for a knock-kneed state and for a bow-legged state, according to the age and the gender of the subject, whether the rehabilitation is performed after injury treatment or the rehabilitation is performed from the standpoint of preventive medicine or sports medicine. In this situation, the threshold value for “d8” may be set for a knock-kneed state and for a bow-legged state, as an absolute position or a relative position, like in the examples described above. The various types of information used in the judging process described above are stored as the setting information in the setting information storage unit 132a. In other words, the judging unit 142a reads the setting information from the setting information storage unit 132a and performs the judging process.

The above example is explained by using the situations where it is judged whether the subject is in a knock-kneed state or a bow-legged state on the basis of the vectors and the angles and where the inter-knee distance “d8” is calculated on the basis of the three-dimensional distance between the two points, when the subject is not positioned facing straight to the motion information acquiring unit 10. However, possible embodiments are not limited to this example. For instance, it is also acceptable to correct the coordinate information of joints as if the subject was positioned facing straight, by using a sagittal plane or a coronal plane of the subject and to calculate an inter-knee distance on the basis of the corrected coordinate information. In that situation, for example, the judging unit 142a calculates a coronal plane of the subject from the coordinates of the joints corresponding to the head, the waist, and the two shoulders of the subject. After that, the judging unit 142a calculates the angle between the calculated coronal plane and the sensor surface of the motion information acquiring unit 10 and corrects the coordinate information of the joints by using the calculated angle. In other words, the judging unit 142a corrects the coordinate information of the joints so that the coronal plane and the sensor surface become parallel to each other and calculates inter-knee information by using values of the corrected coordinate information. Further, the judging unit 142a may further calculate a sagittal plane by using information of the coronal plane and perform the judging process by using information of the calculated sagittal plane.

The above examples are explained by using the situation where the jump training is evaluated by using the distances. However, possible embodiments are not limited to these examples. For instance, the evaluation may be performed on the basis of the gravity point, angles, torsion of the body axis, and the position of the head of the subject, as well as the speed at which the training is performed, and the like. Further, for example, the evaluation may be performed, on the basis of positions of the arms, swings of the arms, or the like.

In the fourth and the fifth embodiments described above, the example is explained in which the prescribed joints (e.g., the tarsi, the ankles, and the knees) are used as the coordinates used for evaluating the quick motion (e.g., the jump training). However, possible embodiments are not limited to this example. For instance, it is acceptable to evaluate a quick motion (e.g., jump training) by using the coordinates of a position that is set between predetermined joints.

In the fourth and the fifth embodiments described above, the example is explained in which the jump training is used as a targeted quick motion. However, possible embodiments are not limited to this example. For instance, a pivot motion may be used as a targeted motion. In that situation, setting information is stored for each targeted motion, so that each motion is evaluated by using various types of threshold values.

As explained above, the motion information processing apparatus 100a of the present disclosure makes it possible to easily and conveniently evaluate the quick motion. Consequently, the subject is able to use the motion information processing apparatus 100a safely, easily, and conveniently, even in a clinic or an assembly hall where few caregivers are available. Further, for example, it is also possible to improve motivation of subjects by saving data of each of the subjects in the motion information processing apparatus 100a and making the data public in a ranking format.

In that situation, for example, the storage unit 130a stores therein the number of times a warning was issued for each of the subjects so that the results are displayed in a ranking format in ascending order of the number of times of warning, either regularly or in response to a publication request from a subject. Further, the subjects may be listed in a ranking format in smaller categories according to the gender, the age, and the like of the subjects, for each of different types of motions.

In the fourth and the fifth embodiments described above, the example is explained in which the jump training is performed as the rehabilitation functional training. However, possible embodiments are not limited to this example. For instance, the present disclosure is applicable to a situation where a sports athlete or the like performs a jump as part of his/her training. In that situation, for example, the motion information processing apparatus 100a is installed in a training gym or the like so that the subject who performs a jump performs the jump training while using the motion information processing apparatus 100a.

The fourth and the fifth embodiments above are explained using the example in which the operator switches on and off the judging function via the input unit 120. However, possible embodiments are not limited to this example. For instance, the judging function may be switched on and off as being triggered by a predetermined motion of the subject. In that situation, for example, the judging unit 142a starts and ends the process of judging whether the motion of the subject indicated by the motion information obtained by the obtaining unit 141a satisfies the certain condition included in the predetermined conditions, on the basis of the predetermined motion of the subject. With this arrangement, for example, the subject is able to switch on and off at a start and an end of the judging process by simply performing the predetermined motion in front of the motion information acquiring unit 10. Thus, even if the subject is by himself/herself, he/she is able to have the jump training evaluated easily.

### Seventh Embodiment

The first to the sixth embodiments have thus been explained. The present disclosure may be carried out in other various modes besides the first to the sixth embodiments described above.

In the first to the sixth embodiments above, the motion information processing apparatus 100 configured to evaluate the squat training is described in the first to the third embodiments, whereas the motion information processing apparatus 100a configured to evaluate the jump training is described in the fourth to the sixth embodiments. These embodiments described above may be performed by mutually-different motion information processing apparatuses. Alternatively, a single motion information processing apparatus may evaluate both the squat training and the jump training.

In that situation, for example, in the motion information processing apparatus, the judging unit judges whether the motion of the subject is a squat motion or a jump motion on the basis of the motion information obtained by the obtaining unit. After that, if it has been determined that the motion is a squat motion, for example, the judging unit judges whether the squat performed by the subject satisfies the certain condition included in the predetermined conditions, on the basis of the predetermined conditions that are used when squat training is performed and are stored in the setting information storage unit. Alternatively, if it has been determined that the motion is a jump motion, for example, the judging unit judges whether the jump performed by the subject satisfies the certain condition included in the predetermined conditions, on the basis of the predetermined conditions that are used when jump training is performed and are stored in the setting information storage unit. After that, the controlling unit provides a judgment result as a notification.

In the first to the third embodiments described above, the examples are explained in which the motion information processing apparatus 100 obtains the motion information of the subject who performs the squat training and displays the evaluation result. In the fourth to the sixth embodiments described above, the examples are explained in which the motion information processing apparatus 100a obtains the motion information of the subject who performs the jump training and displays the evaluation result. However, possible embodiments are not limited to these examples. For instance, these processes may be performed by a service providing apparatus that is provided in a network.

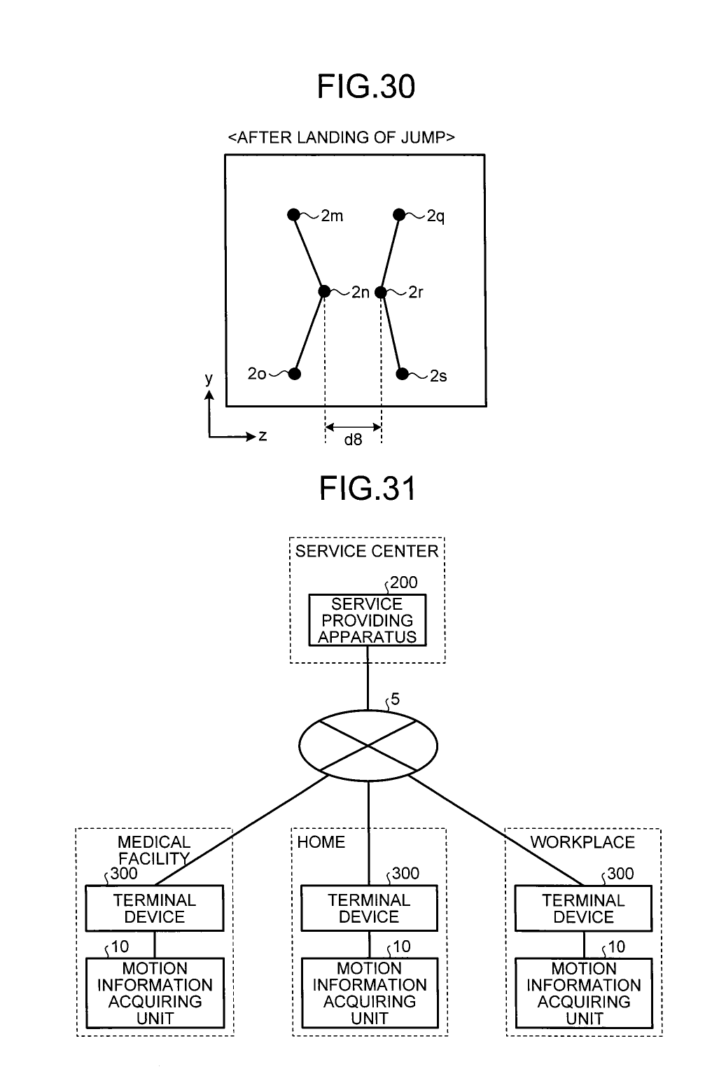

FIG. 31 is a drawing for explaining an example in which a configuration is applied to a service providing apparatus according to a seventh embodiment. As illustrated in FIG. 31, a service providing apparatus 200 is installed in a service center and is connected to, for example, each of terminal devices 300 installed in a medical facility, a home, and a workplace, and a training gym, or the like via a network 5. To each of the terminal devices 300 installed in the medical facility, the home, and the workplace, the motion information acquiring unit 10 is connected. Further, each of the terminal devices 300 has a client function to be able to utilize a service provided by the service providing apparatus 200.

For example, the service providing apparatus 200 is configured to provide each of the terminal devices 300 with the same processes as those performed by the motion information processing apparatus 100 illustrated in FIG. 4, as a service. In other words, the service providing apparatus 200 includes functional units equivalent to the obtaining unit 141, the judging unit 142, and the display controlling unit 143. Further, the functional unit equivalent to the obtaining unit 141 is configured to obtain the motion information of the subject who performs a gradual motion. Further, on the basis of the predetermined conditions for the gradual motion, the functional unit equivalent to the judging unit 142 is configured to judge whether the motion of the subject indicated by the motion information obtained by the functional unit equivalent to the obtaining unit 141 satisfies a certain condition included in the predetermined conditions. Further, the functional unit equivalent to the display controlling unit 143 is configured to exercise control so that a judgment result obtained by the functional unit equivalent to the judging unit 142 is provided as a notification.

Further, for example, the service providing apparatus 200 is configured to provide each of the terminal devices 300 with the same processes as those performed by the motion information processing apparatus 100a, as a service. In other words, the service providing apparatus 200 includes functional units equivalent to the obtaining unit 141a, the judging unit 142a, and the display controlling unit 143a. Further, the functional unit equivalent to the obtaining unit 141a is configured to obtain the motion information of the subject who performs a quick motion. Further, on the basis of the predetermined conditions for the quick motion, the functional unit equivalent to the judging unit 142a is configured to judge whether the motion of the subject indicated by the motion information obtained by the functional unit equivalent to the obtaining unit 141a satisfies a certain condition included in the predetermined conditions. Further, the functional unit equivalent to the display controlling unit 143a is configured to exercise control so that a judgment result obtained by the functional unit equivalent to the judging unit 142a is provided as a notification. The network 5 may be wireless or wired and may be configured by using any arbitrary type of communication network such as the Internet or a Wide Area Network (WAN).

When the service is provided by the service providing apparatus 200 as illustrated in FIG. 31, it is also possible to provide a system via the network S in which subjects who are in locations distant from one another are able to compete with one another. It is also possible to have an arrangement in which a subject is able to receive advice via the network from a caregiver (an advisor) who is in a location distant from the subject.

Further, the motion information processing apparatus 100 according to the first to the third embodiments described above and the motion information processing apparatus 100a according to the fourth to the sixth embodiments described above are merely examples, and the constituent elements thereof may be integrated and separated as necessary. For example, it is acceptable to integrate the motion information storage unit 131 and the setting information storage unit 132 together or to separate the judging unit 142 into a calculating unit configured to calculate the distances and the like and a comparing unit configured to compare the calculated values with the threshold values. Further, for example, it is also acceptable to integrate the motion information storage unit 131a and the setting information storage unit 132a together or to separate the judging unit 142a into a calculating unit configured to calculate the distances and the like and a comparing unit configured to compare the calculated values with the threshold values.

Rule information and a recommended caregiving state for the rehabilitation described in the first to the seventh embodiments above do not necessarily have to be those that are defined by the Japanese Orthopaedic Association, but may be those that are defined by other various organizations. For example, it is acceptable to use various types of regulations and rules that are defined by the “International Society of Orthopaedic Surgery and Traumatology (SICOT)”, “the American Academy of Orthopaedic Surgeons (AAOS)”, “the European Orthopaedic Research Society (EORS)”, “the International Society of Physical and Rehabilitation Medicine (ISPRM)”, or “the American Academy of Physical Medicine and Rehabilitation (AAPM&R)”.

As an example, the AAOS defines various rules for knee exercises using a wall squat. The motion information processing apparatus of the present disclosure may use these rules. In other words, the motion information processing apparatus may use any of the following as a rule for a wall squat performed by a subject: “ensure that the buttocks do not slide lower than the knees”; and “ensure that the knees do not move forward over the toes”.

The motion information processing apparatuses of the present disclosure are able to use various types of rules and regulations defined by various organizations not only for the wall squat mentioned above, but also for other exercises and training programs related to squats and other exercises and training programs related to jumps.

As explained above, according to the first to the seventh embodiments, the motion information processing apparatuses and methods of the present disclosure make it possible to easily and conveniently evaluate the motion of at least one of the squat and the jump.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A motion information processing apparatus comprising:
an obtaining unit configured to obtain motion information of a subject who performs a motion of at least one of a squat and a jump;
a judging unit configured to, on a basis of predetermined conditions for the motion of said at least one of the squat and the jump, judge whether the motion of the subject indicated by the motion information obtained by the obtaining unit satisfies a certain condition included in the predetermined conditions; and
a controlling unit configured to exercise control so that a judgment result obtained by the judging unit is provided as a notification.

2. The motion information processing apparatus according to claim 1, wherein when the judging unit has determined that the squat performed by the subject satisfies the certain condition included in the predetermined conditions, the controlling unit notifies that the motion is normal, whereas when the judging unit has determined that the squat performed by the subject does not satisfy the certain condition included in the predetermined conditions, the controlling unit exercises control so that a warning is issued.

3. The motion information processing apparatus according to claim 2, wherein, as the predetermined conditions used when the squat is performed, the judging unit uses at least one of the following in a series of motions of the squat: how much a knee is projecting with respect to a position of a foot; how much a heel is off a ground; how much an arm is projecting rearward; and how much an upper body is learning forward.

4. The motion information processing apparatus according to claim 1, wherein the judging unit further judges whether the subject is performing the motion of the squat, and if the judging unit has determined that the subject is performing the motion of the squat, the judging unit judges whether the motion of the subject indicated by the motion information obtained by the obtaining unit satisfies the certain condition included in the predetermined conditions.

5. The motion information processing apparatus according to claim 1, further comprising: a receiving unit configured to receive an input operation for setting a predetermined threshold value used for judging whether the certain condition is satisfied, with respect to the predetermined conditions for the motion of the squat used by the judging unit.

6. The motion information processing apparatus according to claim 5, wherein, with respect to the predetermined conditions, the receiving unit receives at least one of a threshold value for an absolute position and a threshold value for a relative position.

7. The motion information processing apparatus according to claim 5, wherein the receiving unit further receives input operations to start and to end the judging process performed by the judging unit.

8. The motion information processing apparatus according to claim 1, wherein, on a basis of a predetermined motion of the subject, the judging unit starts and ends the judging process of judging whether the motion of the subject indicated by the motion information obtained by the obtaining unit satisfies the certain condition included in the predetermined conditions for the motion of the squat.

9. The motion information processing apparatus according to claim 1, wherein when the judging unit has determined that the jump performed by the subject satisfies the certain condition included in the predetermined conditions, the controlling unit notifies that the motion is normal, whereas when the judging unit has determined that the jump performed by the subject does not satisfy the certain condition included in the predetermined conditions, the controlling unit exercises control so that a warning is issued.

10. The motion information processing apparatus according to claim 9, wherein, as the predetermined conditions used when the jump is performed, the judging unit uses at least one of the following: a degree of knock-kneed state and a degree of bow-legged state at a time of landing of the jump.

11. The motion information processing apparatus according to claim 9, wherein, as the predetermined conditions used when the jump is performed, the judging unit uses an opening amount of legs at a time of landing of the jump.

12. The motion information processing apparatus according to claim 1, wherein the judging unit further judges whether the subject is performing the motion of the jump, and if the judging unit has determined that the subject is performing the motion of the jump, the judging unit judges whether the motion of the subject indicated by the motion information obtained by the obtaining unit satisfies the certain condition included in the predetermined conditions.

13. The motion information processing apparatus according to claim 1, further comprising: a receiving unit configured to receive an input operation for setting a predetermined threshold value used for judging whether the certain condition is satisfied, with respect to the predetermined conditions for the motion of the jump used by the judging unit.

14. The motion information processing apparatus according to claim 13, wherein, with respect to the predetermined conditions, the receiving unit receives at least one of a threshold value for an absolute position and a threshold value for a relative position.

15. The motion information processing apparatus according to claim 13, wherein the receiving unit further receives input operations to start and to end the judging process performed by the judging unit.

16. The motion information processing apparatus according to claim 1, wherein, on a basis of a predetermined motion of the subject, the judging unit starts and ends the judging process of judging whether the motion of the subject indicated by the motion information obtained by the obtaining unit satisfies the certain condition included in the predetermined conditions for the motion of the jump.

17. A method implemented by a motion information processing apparatus configured to process motion information, the method comprising:
obtaining the motion information of a subject who performs a motion of at least one of a squat and a jump;
judging, on a basis of predetermined conditions for the motion of said at least one of the squat and the jump, whether the motion of the subject indicated by the motion information satisfies a certain condition included in the predetermined conditions; and
providing a judgment result as a notification.
